(19) United States
(12) Patent Application Publication
(10) Pub. No.: US 2009/0201249 A1
(43) Pub. Date: Aug. 13, 2009

(54) INPUT APPARATUS, CONTROL APPARATUS, CONTROL SYSTEM, AND HANDHELD APPARATUS

(75) Inventor: Kazuyuki Yamamoto, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/329,842

(22) Filed: Dec. 8, 2008

(30) Foreign Application Priority Data
Dec. 7, 2007 (JP) 2007-317747
Dec. 1, 2008 (JP) 2008-306915

(51) Int. Cl. G09G 5/08

(52) U.S. Cl. 345/157

(57) ABSTRACT

An input apparatus controlling a movement of a pointer and an image displayed on a screen is provided and includes a casing, a sensor, an operation section, and a mode switch section. The sensor detects a physical amount corresponding to a movement of the casing. The operation section is used to input an operation. The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

### CROSS REFERENCES TO RELATED APPLICATIONS

The present application claims priority to Japanese Patent Application JP 2007-317747 filed in the Japanese Patent Office on Dec. 7, 2007 and Japanese Patent Application JP 2008-306915 filed in the Japanese Patent Office on Dec. 1, 2008, the entire contents of which are being incorporated herein by reference.

### BACKGROUND

The present disclosure relates to a 3-dimensional operation input apparatus used for operating a GUI (Graphical User Interface), a control apparatus for controlling the GUI based on operational information, a control system including the input apparatus and the control apparatus, and a handheld apparatus.

Pointing devices, particularly a mouse and a touchpad, are used as controllers for GUIs widely used in PCs (Personal Computers). Not just as HIs (Human Interfaces) of PCs as in related art, the GUIs are now starting to be used as an interface for AV equipment and game devices used in living rooms etc. with, for example, televisions as image media. Various pointing devices that a user is capable of operating 3-dimensionally are proposed as controllers for the GUIs of this type (see, for example, Japanese Patent Application Laid-open No. 2001-56743 (paragraphs (0030) and (0031), FIG. 3 and Japanese Patent No. 3,264,291 (paragraphs (0062) and (0063).

Japanese Patent Application Laid-open No. 2001-56743 discloses an input apparatus including angular velocity gyroscopes of two axes, that is, two angular velocity sensors. When a user holds the input apparatus and swings it in a vertical direction, for example, angular velocities about two orthogonal axes are detected by the respective angular velocity sensors, and a signal as positional information of a cursor or the like that is displayed by a display means is generated based on the detected angular velocities. The generated signal is transmitted to a control apparatus, which then carries out control so as to move the cursor on the screen in response to the signal.

The 3-dimensional pointing devices as disclosed in Japanese Patent Application Laid-open No. 2001-56743 and Japanese Patent No. 3,264,291 are required to be provided with, in addition to a function of moving the cursor on the screen, a function of scrolling an image displayed on the screen and a function of zooming in/out on the image.

Specifically, demanded is a pointing device with which simple and intuitional scroll and zoom operations unique to the 3-dimensional operation pointing device different from a 2-dimensional operation pointing device as typified mainly by a mouse are possible. However, both of Japanese Patent Application Laid-open No. 2001-56743 and Japanese Patent No. 3,264,291 include no description on the scroll and zoom of an image using the input apparatus.

In view of the circumstances as described above, there is a need for an input apparatus, a control apparatus, a control system including the input apparatus and the control apparatus, and a handheld apparatus that enable simple and intuitional scroll and zoom operations of an image.

### SUMMARY

According to an embodiment, there is provided an input apparatus controlling a movement of a pointer and an image displayed on a screen, including a casing, a sensor, an operation section, and a mode switch section.

The sensor detects a physical amount corresponding to a movement of the casing.

The operation section is used to input an operation.

The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

In the embodiment, the pointer is moved on the screen in accordance with the movement of the casing during the first mode, and the image is scrolled on the screen in accordance with the movement of the casing during the second mode. In addition, the image is zoomed in/out on the screen in accordance with the movement of the casing during the third mode. In other words, it is possible to carry out a movement operation of the pointer, a scroll operation of the image, and a zoom operation of the image on the screen by moving the casing. Accordingly, simple and intuitional scroll and zoom operations of an image become possible.

In the input apparatus, the operation section may be a single operation section.

In this case, the input apparatus may further include a command output section and a controller.

The command output section outputs a determination command in accordance with the operation to the operation section.

The controller controls the command output section and the mode switch section so that one of the output of the determination command and the switch of any of the first mode, the second mode, and the third mode is executed in accordance with a timing of the operation to the operation section.

In the embodiment, a single operation section includes a function corresponding to a determination button and a function corresponding to a mode switch button. Accordingly, a user can select an icon or the like displayed on the screen or switch any of the first to third modes to the other one of the first to third modes, by a simple operation to the operation section.

In the input apparatus, the controller may control the command output section so that, when the operation to the operation section is canceled within a first time period since a start of the operation, the determination command is output, and control the mode switch section so that, when the operation to the operation section is not canceled within the first time period since the start of the operation, any of the first mode, the second mode, and the third mode is switched to any other one of the first mode, the second mode, and the third mode.

In the embodiment, the determination command is output when the user cancels the operation to the operation section within the first time period. On the other hand, when the user keeps operating the operation section for a time period equal to or longer than the first time period, any of the first to third modes is switched to the other one of the first to third modes. Accordingly, the user can select an icon or the like displayed on the screen or switch any of the first to third modes to the other one of the first to third modes, by a simple operation to the operation section.

In the input apparatus, the controller may control the mode switch section so that, when the operation to the operation section is canceled within the first time period since the start of the operation, and the operation is started again within a second time period since the cancel of the operation but the operation is not canceled within the first time period, any of the first mode, the second mode, and the third mode is switched to any other one of the first mode, the second mode, and the third mode.

Accordingly, the user can select an icon or the like displayed on the screen or switch any of the first to third modes to the other one of the first to third modes, by a simple operation to the operation section.

In the input apparatus, the controller may control the command output section so that, when the operation to the operation section is canceled within a first time period since a start of the operation, the determination command is output, and control the mode switch section so that, when the operation to the operation section is not canceled within the first time period since the start of the operation, any of the first mode, the second mode, and the third mode is switched to any other one of the first mode, the second mode, and the third mode every time a predetermined time passes from after an end of the first time period to the cancel of the operation.

Accordingly, the user can select an icon or the like displayed on the screen or switch any of the first to third modes to the other one of the first to third modes, by a simple operation to the operation section.

The input apparatus may further include a calculation section and an output section.

The calculation section calculates a displacement correspondence amount corresponding to a displacement amount of the pointer that corresponds to the physical amount.

The output section outputs information on the displacement correspondence amount and mode switch information as information indicating the switch of any of the first mode, the second mode, and the third mode to any other one of the first mode, the second mode, and the third mode.

The input apparatus may further include a calculation section and an output section.

The calculation section calculates a displacement correspondence amount corresponding to a displacement amount of the pointer that corresponds to the physical amount, a scroll correspondence amount corresponding to a scroll amount of the image that corresponds to the physical amount, and a zoom correspondence amount corresponding to a zoom amount of the image that corresponds to the physical amount.

The output section outputs information on the displacement correspondence amount during the first mode, information on the scroll correspondence amount during the second mode, and information on the zoom correspondence amount during the third mode.

In the input apparatus, the calculation section may calculate one of the scroll correspondence amount and the zoom correspondence amount based on the displacement correspondence amount.

In the input apparatus, the calculation section may calculate one of the scroll correspondence amount and the zoom correspondence amount by multiplying the displacement correspondence amount by a gain that increases along with the displacement correspondence amount.

Accordingly, because the scroll correspondence amount is calculated by multiplying the displacement correspondence amount by the gain of a small value when the casing is moved 3-dimensionally at a low velocity, more accurate scroll and zoom operations become possible. Meanwhile, because the displacement correspondence amount is multiplied by the gain of a large value when the casing is moved at a high velocity, extremely-fast scroll and zoom operations become possible. Accordingly, an operation of scrolling a long file, for example, is facilitated.

In the input apparatus, the calculation section may calculate one of the scroll correspondence amount and the zoom correspondence amount by integrating the displacement correspondence amount.

Accordingly, steady scroll and zoom operations become possible without having to move the casing much.

In the input apparatus, the calculation section may calculate a first scroll correspondence amount based on a first displacement correspondence amount corresponding to the displacement amount of the pointer in a first direction on the screen, and a second scroll correspondence amount based on a second displacement correspondence amount corresponding to the displacement amount of the pointer in a second direction orthogonal to the first direction on the screen.

In this case, the input apparatus may further include an output controller.

The output controller controls the output section so that, when the first displacement correspondence amount is smaller than the second displacement correspondence amount during the second mode, the output of the first scroll correspondence amount is stopped.

Accordingly, it becomes possible to bias a direction of the scroll operation in a horizontal direction or a vertical direction on the screen, for example, thus facilitating operations of a vertically-long file or a horizontally-long file.

Here, the case of stopping the output of the scroll correspondence amount includes a case of starting an output with the scroll correspondence amount set to 0.

In the input apparatus, one of the scroll correspondence amount and the zoom correspondence amount may have a value the same as that of the displacement correspondence amount.

In the input apparatus, the mode switch section may switch any of the first mode, the second mode, and the third mode to any other one of the first mode, the second mode, and the third mode every time a predetermined time passes since a start of the operation to the operation section until the operation is canceled. Alternatively, the mode switch section may switch any of the first mode, the second mode, and the third mode to any other one of the first mode, the second mode, and the third mode every time the operation section is operated.

Accordingly, the user can easily make a switch among the first to third modes.

In the input apparatus, the operation section may be a 2-step operation section capable of performing a 2-step switch.

Accordingly, the user can easily make a switch among the first to third modes.

In the input apparatus, the sensor may include at least one of a biaxial angular velocity sensor, a biaxial acceleration sensor, and a biaxial angle sensor.

According to another embodiment, there is provided an input apparatus controlling a movement of a pointer and an image displayed on a screen, including a casing, a sensor, a single operation section, a command output section, a mode switch section, and a controller.

The sensor detects a physical amount corresponding to a movement of the casing.

The operation section is used to input an operation.

The command output section outputs a determination command in accordance with the operation to the operation section.

The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

The controller controls the command output section and the mode switch section so that one of the output of the determination command and the switch of any of the first mode, the second mode, and the third mode is executed in accordance with a timing of the operation to the operation section.

In the embodiment, a single operation section includes a function corresponding to a determination button and a function corresponding to a mode switch button for switching the first mode to the second mode and vise versa. Alternatively, a single operation section includes a function corresponding to a determination button and a function corresponding to a mode switch button for switching the first mode to the third mode and vise versa. Accordingly, the user can select an icon or the like displayed on the screen or switch any of the first to third modes to the other one of the first to third modes, by a simple operation to the operation section.

According to an embodiment, there is provided a control apparatus controlling display of a pointer and an image displayed on a screen in accordance with information output from an input apparatus including a casing, a sensor to detect a physical amount corresponding to a movement of the casing, an operation section through which an operation is input, a mode switch section to make a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section, a calculation section to calculate a displacement correspondence amount corresponding to a displacement amount of the pointer that corresponds to the physical amount, and an output section to output information on the displacement correspondence amount and mode switch information as information indicating the switch of any of the first mode, the second mode, and the third mode to any other one of the first mode, the second mode, and the third mode, the control apparatus including a reception section, a calculation section, and a display controller.

The reception section receives the information on the displacement correspondence amount and the mode switch information.

The calculation section calculates a scroll correspondence amount corresponding to a scroll amount of the image based on the displacement correspondence amount during the second mode, and calculates a zoom correspondence amount corresponding to a zoom amount of the image based on the displacement correspondence amount during the third mode.

The display controller controls display of a movement of the pointer by the displacement correspondence amount, display of scroll of the image by the scroll correspondence amount, and display of zoom of the image by the zoom correspondence amount.

According to another embodiment, there is provided a control apparatus receiving, from an input apparatus including a casing, a sensor to detect a physical amount corresponding to a movement of the casing, and an operation section through which an operation is input, information on the physical amount and information on the operation, and controlling display of a pointer and an image displayed on a screen, the control apparatus including a reception section, a calculation section, and a mode switch section.

The reception section receives the information on the physical amount and the information on the operation.

The calculation section calculates a displacement correspondence amount corresponding to a displacement amount of the pointer on the screen that corresponds to the information on the physical amount, a scroll correspondence amount corresponding to a scroll amount of the image on the screen that corresponds to the information on the physical amount, and a zoom correspondence amount corresponding to a zoom amount of the image on the screen that corresponds to the information on the physical amount.

The mode switch section makes a switch among a first mode for controlling display of a movement of the pointer based on the displacement correspondence amount, a second mode for controlling display of scroll of the image based on the scroll correspondence amount, and a third mode for controlling display of zoom of the image based on the zoom correspondence amount, in accordance with the information on the operation.

According to an embodiment, there is provided a control system controlling display of a pointer and an image displayed on a screen, including an input apparatus and a control apparatus.

The input apparatus includes a casing, a sensor, an operation section, a mode switch section, a calculation section, and an output section.

The sensor detects a physical amount corresponding to a movement of the casing.

The operation section is used to input an operation.

The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

The calculation section calculates a displacement correspondence amount corresponding to a displacement amount of the pointer that corresponds to the physical amount.

The output section outputs information on the displacement correspondence amount and mode switch information as information indicating the switch of any of the first mode, the second mode, and the third mode to any other one of the first mode, the second mode, and the third mode.

The control apparatus includes a reception section, a calculation section, and a display controller.

The reception section receives the information on the displacement correspondence amount and the mode switch information.

The calculation section calculates a scroll correspondence amount corresponding to a scroll amount of the image based on the displacement correspondence amount during the second mode, and calculates a zoom correspondence amount corresponding to a zoom amount of the image based on the displacement correspondence amount during the third mode.

The display controller controls display of a movement of the pointer by the displacement correspondence amount, display of scroll of the image by the scroll correspondence amount, and display of zoom of the image by the zoom correspondence amount.

According to another embodiment, there is provided a control system controlling display of a pointer and an image displayed on a screen, including an input apparatus and a control apparatus.

The input apparatus includes a casing, a sensor, an operation section, a mode switch section, a calculation section, and an output section.

The sensor detects a physical amount corresponding to a movement of the casing.

The operation section is used to input an operation.

The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

The calculation section calculates a displacement correspondence amount corresponding to a displacement amount of the pointer that corresponds to the physical amount, a scroll correspondence amount corresponding to a scroll amount of the image that corresponds to the physical amount, and a zoom correspondence amount corresponding to a zoom amount of the image that corresponds to the physical amount.

The output section outputs information on the displacement correspondence amount during the first mode, information on the scroll correspondence amount during the second mode, and information on the zoom correspondence amount during the third mode.

The control apparatus includes a reception section and a display controller.

The reception section receives the information on the displacement correspondence amount, the information on the scroll correspondence amount, and the information on the zoom correspondence amount.

The display controller controls display of a movement of the pointer by the displacement correspondence amount, display of scroll of the image by the scroll correspondence amount, and display of zoom of the image by the zoom correspondence amount.

According to another embodiment, there is provided a control system controlling display of a pointer and an image displayed on a screen, including an input apparatus and a control apparatus.

The input apparatus includes a casing, a sensor, an operation section, and an output section.

The sensor detects a physical amount corresponding to a movement of the casing.

The operation section is used to input an operation.

The output section outputs information on the physical amount and information on the operation.

The control apparatus includes a reception section, a calculation section, and a mode switch section.

The reception section receives the information on the physical amount and the information on the operation.

The calculation section calculates a displacement correspondence amount corresponding to a displacement amount of the pointer on the screen, a scroll correspondence amount corresponding to a scroll amount of the image on the screen, and a zoom correspondence amount corresponding to a zoom amount of the image on the screen, the displacement correspondence amount, the scroll correspondence amount, and the zoom correspondence amount corresponding to the information on the physical amount.

The mode switch section makes a switch among a first mode for controlling display of a movement of the pointer based on the displacement correspondence amount, a second mode for controlling display of scroll of the image based on the scroll correspondence amount, and a third mode for controlling display of zoom of the image based on the zoom correspondence amount, in accordance with the information on the operation.

According to an embodiment, there is provided a handheld apparatus controlling a movement of a pointer and an image displayed on a screen, including a casing, a display section, a sensor, an operation section, a mode switch section, and a display controller.

The display section displays the screen.

The sensor detects a physical amount corresponding to a movement of the casing.

The operation section is used to input an operation.

The mode switch section makes a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

The display controller controls display of the movement of the pointer during the first mode, display of scroll of the image during the second mode, and display of zoom of the image during the third mode.

According to an embodiment, there is provided a control method including detecting a physical amount corresponding to a movement of a casing.

The control method further includes inputting an operation.

In accordance with the operation, a switch is made among a first mode for moving a pointer on a screen based on the detected physical amount, a second mode for scrolling an image on the screen based on the detected physical amount, and a third mode for zooming in/out on the image on the screen based on the detected physical amount.

In the descriptions above, elements described as “ . . . means” may be realized by hardware, or may be realized by both software and hardware. In the case of realization by both the software and hardware, the hardware includes at least a storage device for storing a software program.

Typically, the hardware is constituted by selectively using at least one of a sensor, a CPU (Central Processing Unit), an MPU (Micro Processing Unit), a RAM (Random Access Memory), a ROM (Read Only Memory), a DSP (Digital Signal Processor), an FPGA (Field Programmable Gate Array), an ASIC (Application Specific Integrated Circuit), a NIC (Network Interface Card), a WNIC (Wireless NIC), a modem, an optical disk, a magnetic disk, and a flash memory.

As described above, according to the embodiments, an input apparatus, a control apparatus, a control system including the input apparatus and the control apparatus, and a handheld apparatus that enable simple and intuitional scroll and zoom operations of an image can be provided.

These and other objects, features and advantages will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a diagram showing a control system according to an embodiment;

FIG. 2 is a perspective diagram showing an input apparatus;

FIG. 3 is a diagram schematically showing an internal structure of the input apparatus;

FIG. 4 is a block diagram showing an electrical structure of the input apparatus;

FIG. 5 is a diagram showing an example of a screen displayed on a display apparatus;

FIG. 6 is a diagram showing a state where a user is holding the input apparatus;

FIG. 7 are diagrams for illustrating typical examples of ways of moving the input apparatus and ways a pointer moves on a screen;

FIG. 8 is a perspective diagram showing a sensor unit;

FIG. 9 is a flowchart showing an operation of the input apparatus when an operation section is not operated;

FIG. 10 is a flowchart showing an operation of the input apparatus when the operation section is operated;

FIG. 11 is a timing chart in a case where the user presses a button and releases the button within a first time period;

FIG. 12 is a timing chart in a case where the user press and holds the button for a time period equal to or longer than the first time period;

FIG. 13 is a timing chart in a case where, after the user has pressed and released the button within the first time period, the user presses the button again within a second time period and holds the button for a time period equal to or more than the first time period;

FIG. 14 is a functional block diagram of the input apparatus for realizing the operation shown in FIG. 10;

FIG. 15 is a schematic diagram showing an LED display section included in an input apparatus according to another embodiment;

FIG. 16 is a flowchart showing an operation of the input apparatus according to the embodiment;

FIG. 17 is a timing chart in a case where the pressed button is released within the first time period;

FIG. 18 is a timing chart in a case where the button is pressed for a time period equal to or longer than the first time period;

FIG. 19 are schematic diagrams each showing an operation section included in an input apparatus according to another embodiment;

FIG. 20 is a flowchart showing an operation of the input apparatus according to the embodiment;

FIG. 21 are schematic diagrams each showing an operation section included in an input apparatus according to another embodiment;

FIG. 22 is a flowchart showing an operation of the input apparatus according to the embodiment;

FIG. 23 are schematic diagrams each showing an operation section included in an input apparatus according to another embodiment;

FIG. 24 is a flowchart showing an operation of the input apparatus according to the embodiment;

FIG. 25 is a perspective diagram of an input apparatus according to another embodiment;

FIG. 26 is a flowchart showing an operation of the input apparatus according to the embodiment

FIG. 27 is a flowchart showing an operation of an input apparatus according to another embodiment;

FIG. 28 is a diagram showing an input apparatus in which a wheel button is provided on a side surface of a casing;

FIG. 29 is a flowchart showing an operation of an input apparatus according to another embodiment;

FIG. 30 are timing charts for illustrating the operation shown in FIG. 29;

FIG. 31 is a flowchart showing an operation of an input apparatus according to another embodiment;

FIG. 32 is a timing chart for illustrating the operation shown in FIG. 31;

FIG. 33 is a flowchart showing an operation of an input apparatus according to another embodiment;

FIG. 34 is a timing chart for illustrating the operation shown in FIG. 33;

FIG. 35 is a flowchart showing an operation of an input apparatus according to another embodiment;

FIG. 36 is a flowchart showing an operation of an input apparatus according to another embodiment;

FIG. 37 is a flowchart showing an operation of the input apparatus regarding a scroll correspondence amount calculation method according to the embodiment;

FIG. 38 are graphs respectively showing examples of profiles of a gain value Kₓ and/or K_{y} and scroll correspondence amount obtained from the gain profile;

FIG. 39 is a diagram showing another example of the scroll profile;

FIG. 40 is a flowchart showing an operation of an input apparatus regarding a scroll correspondence amount calculation method according to another embodiment;

FIG. 41 is a flowchart showing an operation of the input apparatus regarding a zoom correspondence amount calculation method according to the embodiment; and

FIG. 42 is a flowchart showing an operation of an input apparatus regarding a zoom correspondence amount calculation method according to another embodiment.

### DETAILED DESCRIPTION

Hereinafter, embodiments will be described with reference to the drawings.

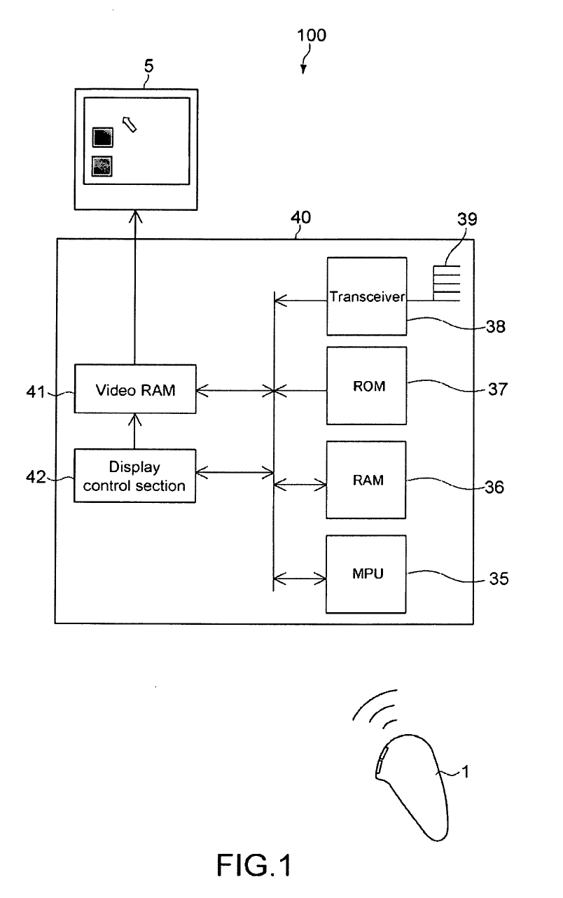

FIG. 1 is a diagram showing a control system according to an embodiment. A control system 100 includes a display apparatus 5, a control apparatus 40, and an input apparatus 1.

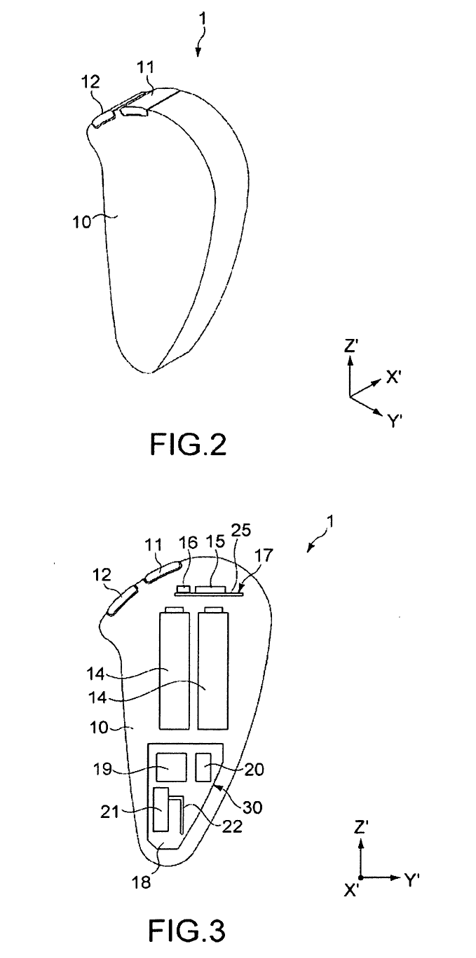

FIG. 2 is a perspective diagram showing the input apparatus 1. The input apparatus 1 is of a size that a user is capable of holding. The input apparatus 1 includes a casing 10 and operation sections which are, for example, a button 11 provided in the middle of an upper portion of the casing 10 and a button 12 adjacent thereto (hereinafter, may collectively be referred to as operation section).

Typically, the buttons 11 and 12 are each a press-type button, and push buttons or capacitance-type touch buttons are used for the buttons 11 and 12. An operation section 23 is not limited to the press-type button, and a bar-type operation section 23 that is operated with one end as a fulcrum, or a slide-type operation section 23 may be used instead. The operation section 23 includes a built-in switch (not shown) which detects an operation made to the operation section by the user and outputs an operation signal. An optical sensor or a capacitance sensor may be used as the switch for outputting the operation signal.

The button 11 functions as a left button of a mouse as an input device for a PC. The button 12 adjacent to the button 11 functions as a right button of the mouse. For example, an icon 4 (see FIG. 5) may be selected by clicking the button 11, and a file may be opened by double-clicking the button 11. The icons are images on a screen 3 representing functions of programs, execution commands, file contents, and the like of the computer. The function of the button 11 and the like will be described later in detail.

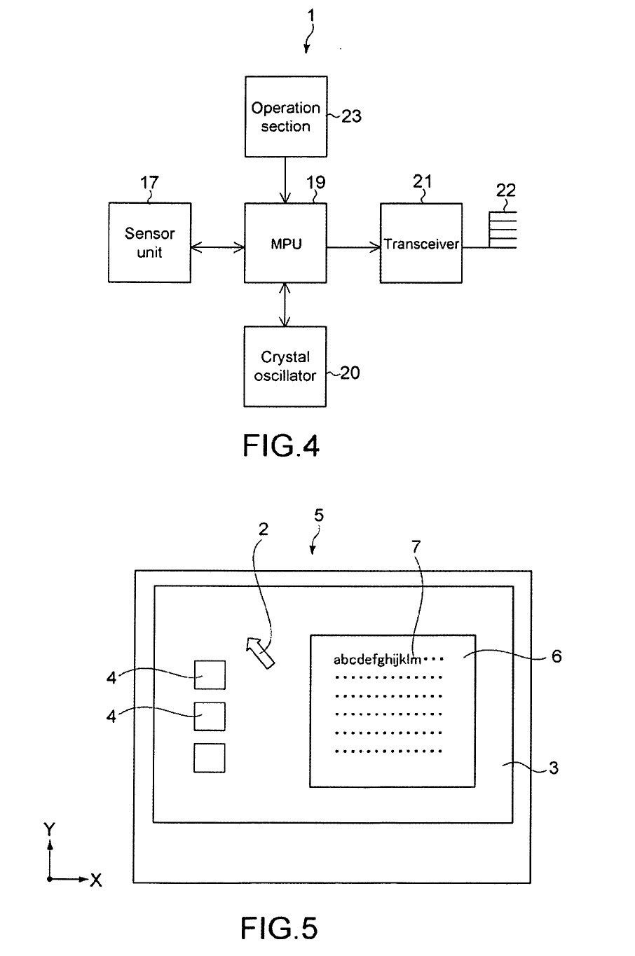

FIG. 3 is a diagram schematically showing an internal structure of the input apparatus 1. FIG. 4 is a block diagram showing an electrical structure of the input apparatus 1.

The input apparatus 1 includes a sensor unit 17 (detection means), a control unit 30, and batteries 14.

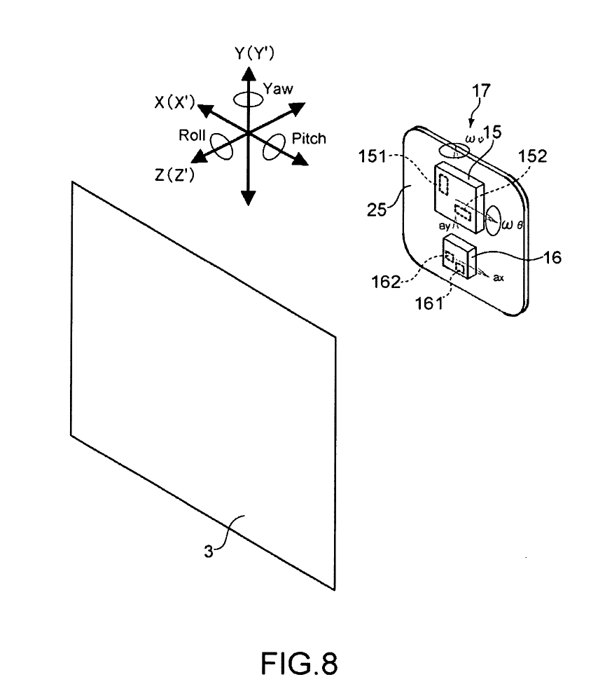

FIG. 8 is a perspective diagram showing the sensor unit 17.

The sensor unit 17 includes an acceleration sensor unit 16. The acceleration sensor unit 16 detects accelerations in different angles such as along two orthogonal axes (X′ axis and Y′ axis). Specifically, the acceleration sensor unit 16 includes two sensors, that is, a first acceleration sensor 161 for an X′-axis direction and a second acceleration sensor 162 for a Y′-axis direction.

The sensor unit 17 further includes an angular velocity sensor unit 15. The angular velocity sensor unit 15 detects angular accelerations about the two orthogonal axes. Specifically, the angular velocity sensor unit 15 includes two sensors, that is, a first angular velocity sensor 151 for a yaw direction and a second angular velocity sensor 152 for a pitch direction. The acceleration sensor unit 16 and the angular velocity sensor unit 15 are packaged and mounted on a circuit board 25.

As each of the first angular velocity sensor 151 for the yaw direction and the second angular velocity sensor 152 for the pitch direction, a vibration gyro sensor for detecting Coriolis force in proportion with an angular velocity is used. As each of the first acceleration sensor 161 for the X′-axis direction and the second acceleration sensor 162 for the Y′-axis direction, any sensor such as a piezoresistive sensor, a piezoelectric sensor, or a capacitance sensor may be used. Each of the first angular velocity sensor 151 and the second angular velocity sensor 152 is not limited to the vibration gyro sensor, and a rotary top gyro sensor, a ring laser gyro sensor, a gas rate gyro sensor, and the like may also be used.

In the description made with reference to FIGS. 2 and 3, a longitudinal direction of the casing 10 is referred to as Z′ direction, a thickness direction of the casing 10 is referred to as X′ direction, and a width direction of the casing 10 is referred to as Y′ direction, for convenience. In this case, the sensor unit 17 is incorporated into the casing 10 such that a surface of the circuit board 25 on which the acceleration sensor unit 16 and the angular velocity sensor unit 15 are mounted is substantially in parallel with an X′-Y′ plane. As described above, the acceleration sensor unit 16 and the angular velocity sensor unit 15 each detect physical amounts with respect to the two axes, that is, the X′ axis and the Y′ axis.

In the specification, a coordinate system that moves along with the input apparatus 1, that is, a coordinate system fixed to the input apparatus 1 is expressed using the X′ axis, Y′ axis, and Z′ axis, whereas a coordinate system stationary on earth, that is, an inertial coordinate system is expressed using the X axis, Y axis, and Z axis. In descriptions below, with regard to a movement of the input apparatus 1, a rotational direction about the X′ axis is sometimes referred to as pitch direction, a rotational direction about the Y′ axis is sometimes referred to as yaw direction, and a rotational direction about the Z′ axis (roll axis) is sometimes referred to as roll direction.

The control unit 30 includes a main substrate 18, an MPU (Micro Processing Unit) 19 (or CPU) (control means) mounted on the main substrate 18, a crystal oscillator 20, a transceiver 21, and an antenna 22 printed on the main substrate 18.

The MPU 19 includes built-in volatile and nonvolatile memories requisite therefor. A detection signal output from the sensor unit 17, an operation signal output from the operation section, and other signals are input to the MPU 19. The MPU 19 executes various types of operational processing to generate predetermined control signals in response to those input signals. The memory may be provided separate from the MPU 19.

Typically, the sensor unit 17 outputs analog signals. In this case, the MPU 19 includes an A/D (Analog/Digital) converter. Alternatively, the sensor unit 17 may include the A/D converter.

The transceiver 21 (output means, command output means) transmits control signals generated in the MPU 19 to the control apparatus 40 as RF radio signals via the antenna 22. Moreover, the transceiver 21 is also capable of receiving various signals transmitted from the control apparatus 40.

The crystal oscillator 20 generates clocks and supplies the clocks to the MPU 19. As the batteries 14, dry cell batteries, rechargeable batteries, or the like are used.

The control apparatus 40 includes an MPU 35 (or CPU), a RAM 36, a ROM 37, a video RAM 41, a display control section 42, an antenna 39, and a transceiver 38.

The transceiver 38 (reception means) receives the control signal transmitted from the input apparatus 1 via the antenna 39. Moreover, the transceiver 38 is also capable of transmitting various predetermined signals to the input apparatus 1. The MPU 35 analyzes the control signal and executes various types of operational processing. The display control section 42 mainly generates screen data to be displayed on a screen 3 of the display apparatus 5 under control of the MPU 35. The video RAM 41 serves as a work area of the display control section 42 and temporarily stores the screen data generated by the display control section 42.

The control apparatus 40 may be an apparatus dedicated to the input apparatus 1, or may be a PC or the like. The control apparatus 40 is not limited to the apparatus dedicated to the input apparatus 1, and may be a computer integrally formed with the display apparatus 5, an audio/visual device, a projector, a game device, a car navigation device, or the like.

Examples of the display apparatus 5 include a liquid crystal display and an EL (Electro-Luminescence) display, but are not limited thereto. The display apparatus 5 may alternatively be an apparatus integrally formed with a display and capable of receiving television broadcasts and the like, or an apparatus in which such a display and the control apparatus 40 are integrated.

FIG. 5 is a diagram showing an example of the screen 3 displayed on the display apparatus 5. On the screen 3, UIs such as icons 4 and a pointer 2 are displayed. Moreover, on the screen 3, an image 6 containing a plurality of letters 7, for example, is displayed. It should be noted that on the screen 3, the horizontal direction is referred to as X-axis direction and the vertical direction is referred to as Y-axis direction.

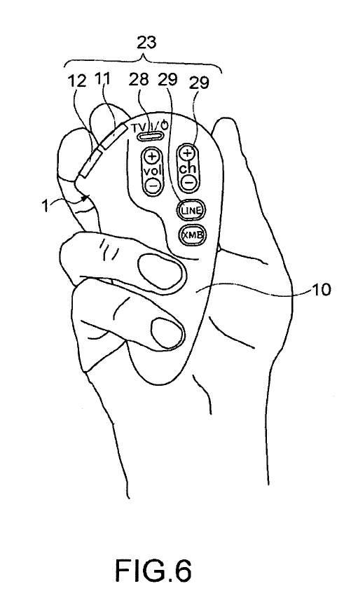

FIG. 6 is a diagram showing a state where a user is holding the input apparatus 1. As shown in FIG. 6, the input apparatus 1 may include, as the operation section 23, in addition to the buttons 11 and 12, various operation buttons 29 such as those provided to a remote controller for operating a television or the like and a power switch 28, for example. When the user moves the input apparatus 1 in the air or operates the operation section 23 while holding the input apparatus 1 as shown in the figure, a command signal is generated and output to the control apparatus 40, and the control apparatus 40 controls the UI.

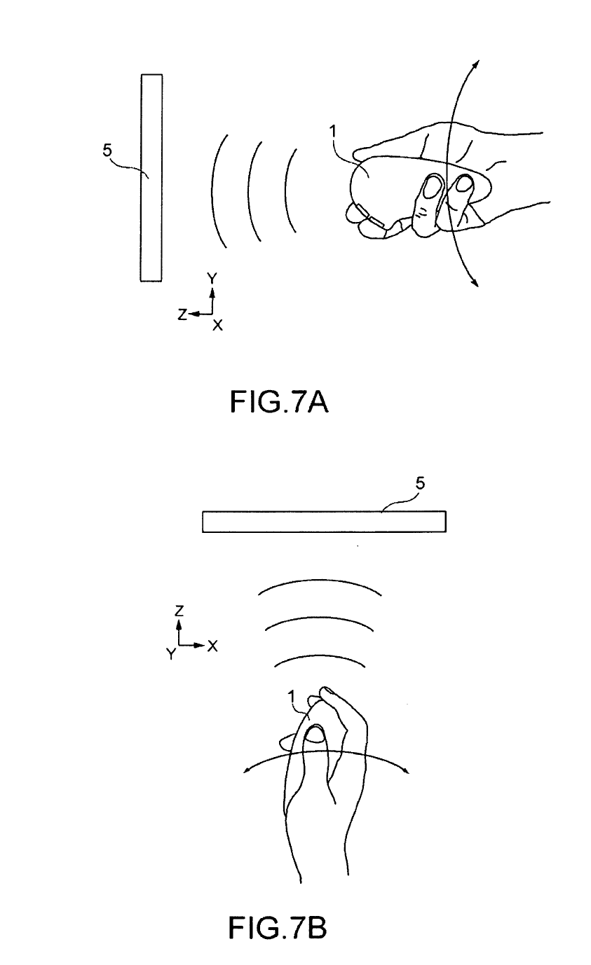

Subsequently, typical examples of ways of moving the input apparatus 1 and ways the pointer 2 moves on the screen 3 in response thereto will be described. FIGS. 7A and 7B are explanatory diagrams therefor.

As shown in FIGS. 7A and 7B, the user holds the input apparatus 1 so as to aim the buttons 11 and 12 side of the input apparatus 1 at the display apparatus 5. The user holds the input apparatus 1 such that a thumb is located on an upper side and a pinky is located on a lower side as in handshakes. In this state, the circuit board 25 (see FIG. 8) of the sensor unit 17 is substantially in parallel with the screen 3 of the display apparatus 5. Herein, the two axes as detection axes of the sensor unit 17 correspond to the horizontal axis (X axis) and the vertical axis (Y axis) on the screen 3, respectively. Hereinafter, the position of the input apparatus 1 as shown in FIGS. 7A and 7B is referred to as reference position.

As shown in FIG. 7A, in the state where the input apparatus 1 is in the reference position, the user swings a wrist or an arm in the vertical direction, that is, the pitch direction. At this time, the second acceleration sensor 162 for the Y′-axis direction detects an acceleration a_{y} the Y′-axis direction, and the second angular velocity sensor 152 for the pitch direction detects an angular velocity ω_{θ} about the X′ axis. Based on the detected physical amounts, the control apparatus 40 controls the display of the pointer 2 such that the pointer 2 moves in the Y-axis direction.

Meanwhile, as shown in FIG. 7B, in the state where the input apparatus 1 is in the reference position, the user swings the wrist or the arm in the horizontal direction, that is, the yaw direction. At this time, the first acceleration sensor 161 for the X′-axis direction detects an acceleration aₓ in the X′-axis direction, and the first angular velocity sensor 151 for the yaw direction detects an angular velocity ω_{ψ} about the Y′ axis. Based on the detected physical amounts, the control apparatus 40 controls the display of the pointer 2 such that the pointer 2 moves in the X-axis direction.

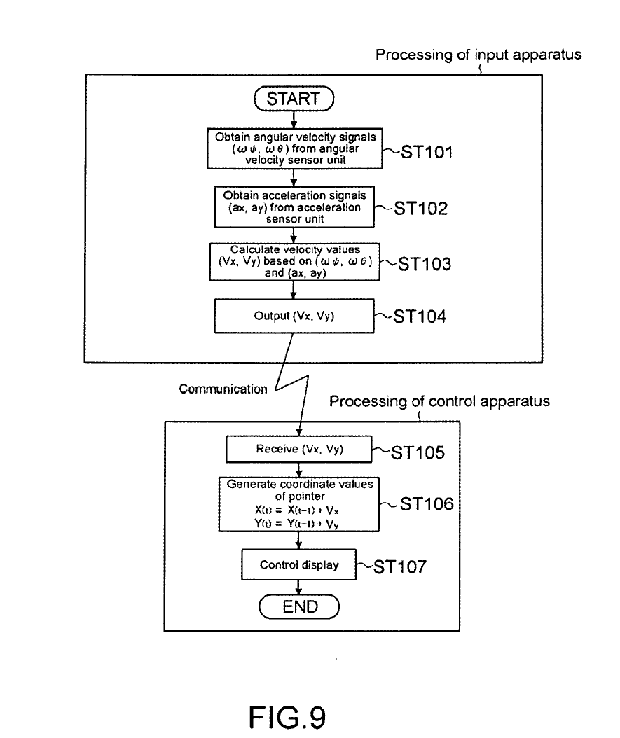

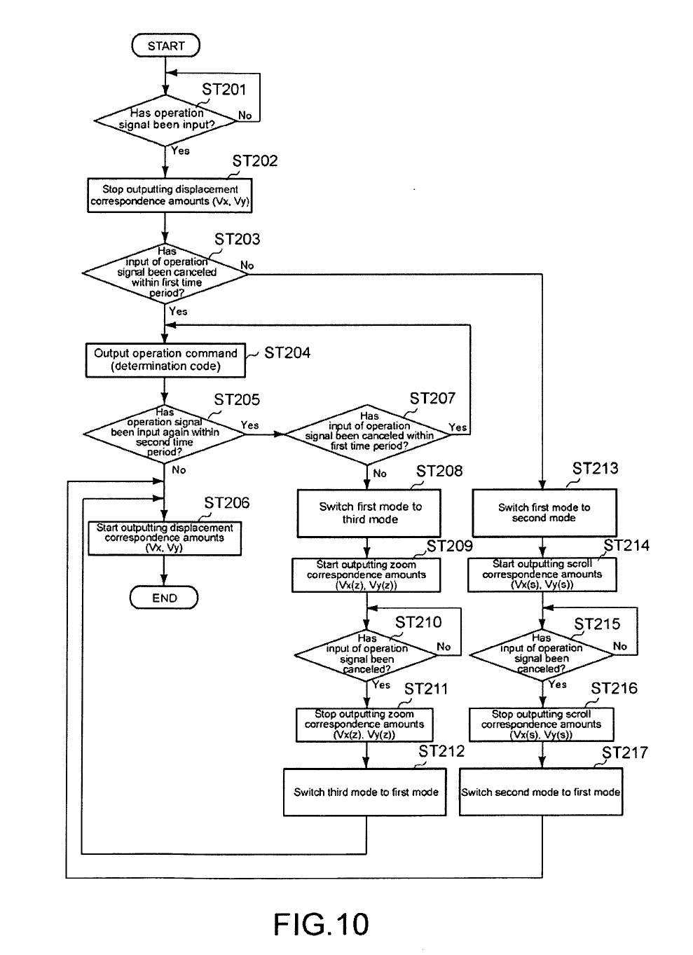

Next, descriptions will be given on operations of the control system 100 structured as described above. FIGS. 9 and 10 are flowcharts showing the operations.

First, descriptions will be given on an operation of the control system 100 carried out when the user is not operating the operation section 23 provided on the input apparatus 1. FIG. 9 is a flowchart showing the operation carried out when the operation section 23 is not operated.

As shown in FIG. 9, when power of the input apparatus 1 is turned on by the user pressing the power switch 28, for example, biaxial angular velocity signals are output from the angular velocity sensor unit 15. A first angular velocity value ω_{ψ} and a second angular velocity value ω_{θ} obtained from the angular velocity signals are input to the MPU 19 (Step 101).

In addition, when the power of the input apparatus 1 is turned on, biaxial acceleration signals are output from the acceleration sensor unit 16. A first acceleration value aₓ and a second acceleration value a_{y} obtained from the biaxial acceleration signals are input to the MPU 19 (Step 102). It should be noted that in FIG. 9, the acceleration signals are obtained by the acceleration sensor unit after the angular velocity signals are obtained by the angular velocity sensor unit. However, the order of obtaining the signals is not limited thereto, and it is also possible to obtain the angular velocity signals after obtaining the acceleration signals, or obtain the acceleration signals and the angular velocity signals in parallel (at the same time).

Based on the acceleration values (aₓ, a_{y}) and angular velocity values (ω_{ψ}, ω_{θ}), the MPU 19 calculates velocity values (first velocity value Vₓ, second velocity value V_{y}) by a predetermined operation (Step 103) (calculation means). The first velocity value Vₓ is a velocity value in a direction along the X′ axis and the second velocity value V_{y} is a velocity value in a direction along the Y′ axis.

As a method of calculating the velocity values (Vₓ, V_{y}), there is a method in which the MPU 19 calculates the velocity values by integrating the acceleration values (aₓ, a_{y}), and the angular velocity values (ω_{ψ}, ω_{θ}) are used as an adjunct to the integration operation, for example.

Alternatively, the MPU 19 may calculate radius gyrations (R_{ω}, R_{θ}) of the movement of the input apparatus 1 by dividing the acceleration values (aₓ, a_{y}) by angular acceleration values (Δω_{ψ}, Δω_{θ}). In this case, the velocity values (Vₓ, V_{y}) can be calculated by multiplying the radius gyrations (R_{ψ}, R_{θ}) by the angular velocity values (ω_{ψ}, ω_{θ}). The radius gyrations (R_{ψ}, R_{θ}) may also be calculated by dividing acceleration change rates (Δaₓ, Δa_{y}) by angular acceleration change rates (Δ(Δω_{ψ}),Δ(Δψ_{θ})).

By calculating the velocity values using the above calculation methods, an operational feeling that matches an intuitional operation of the user can be obtained, and the movement of the pointer 2 on the screen 3 also matches the movement of the input apparatus 1 accurately. However, the velocity values (Vₓ, V_{y}) do not always have to be calculated by the above calculation methods. For example, the velocity values (Vₓ, V_{y}) may be calculated by simply integrating the acceleration values (aₓ, a_{y}). Alternatively, the detected angular velocity values (ω_{ψ}, ω_{θ}) may be used as the velocity values (Vₓ, V_{y}) of the casing as they are. It is also possible to obtain angular acceleration values (Δω_{ψ}, Δω_{θ}) by subjecting the detected angular velocity values (ω_{ψ}, ω_{θ}) to temporal differentiation and use them as the acceleration values of the casing.

The MPU 19 transmits information on the calculated velocity values (Vₓ, V_{y}) to the control apparatus 40 via the transceiver 21 and the antenna 22 (Step 104).

The MPU 35 of the control apparatus 40 receives the information on the velocity values (Vₓ, V_{y}) via the antenna 39 and the transceiver 38 (Step 105). In this case, the input apparatus 1 transmits the velocity values (Vₓ, V_{y}) every predetermined number of clocks, that is, per unit time, and the control apparatus 40 receives the information on the velocity values (Vₓ, V_{y}) every predetermined number of clocks.

Upon receiving the velocity values, the MPU 35 of the control apparatus 40 adds the velocity values to coordinate values, respectively, using Equations (1) and (2) below, to thus generate new coordinate values (X(t), Y(t)) (Step 106). By generating the coordinate values, the MPU 35 controls the display such that the pointer 2 moves on the screen 3 (Step 107) (display control means).

X(t)=X(t−1)+Vₓ (1)

Y(t)=Y(t−1)+V_{y} (2)

As expressed in Equations (1) and (2), the velocity values (Vₓ, V_{y}) correspond to amounts corresponding to a displacement, that is, displacement correspondence amounts of the pointer 2 in the X- and Y-axis directions per unit time. In descriptions below, the velocity values calculated by the MPU 19 are described as the displacement correspondence amounts.

Next, descriptions will be given on an operation of the input apparatus 1 carried out when the user operates the operation section 23. FIG. 10 is a flowchart showing the operation of the input apparatus 1 carried out when the operation section 23 is operated. In the figure, a case where the user operates the button 11 of the operation section 23 will be described.

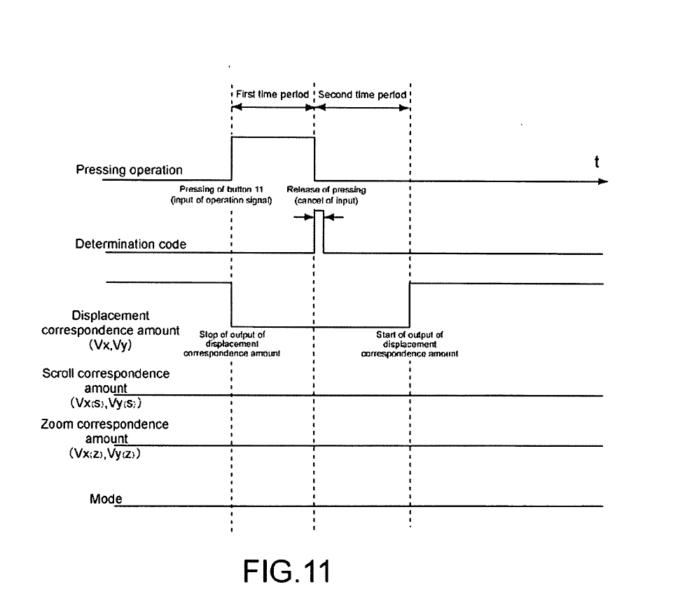

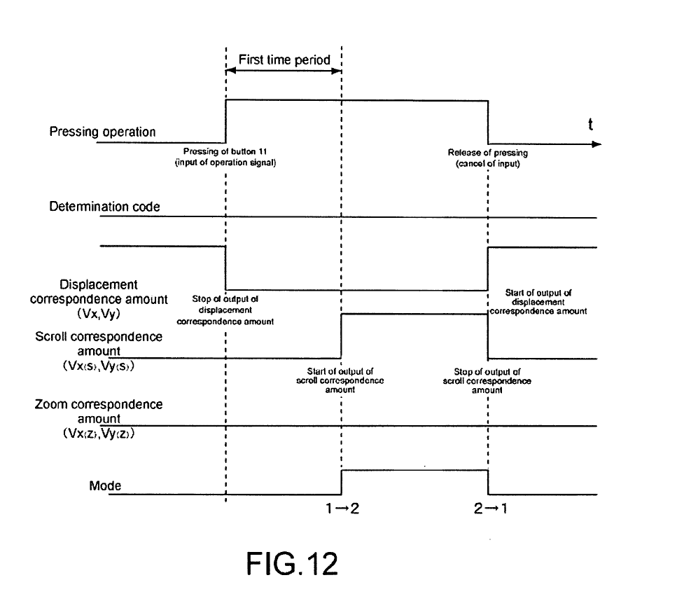

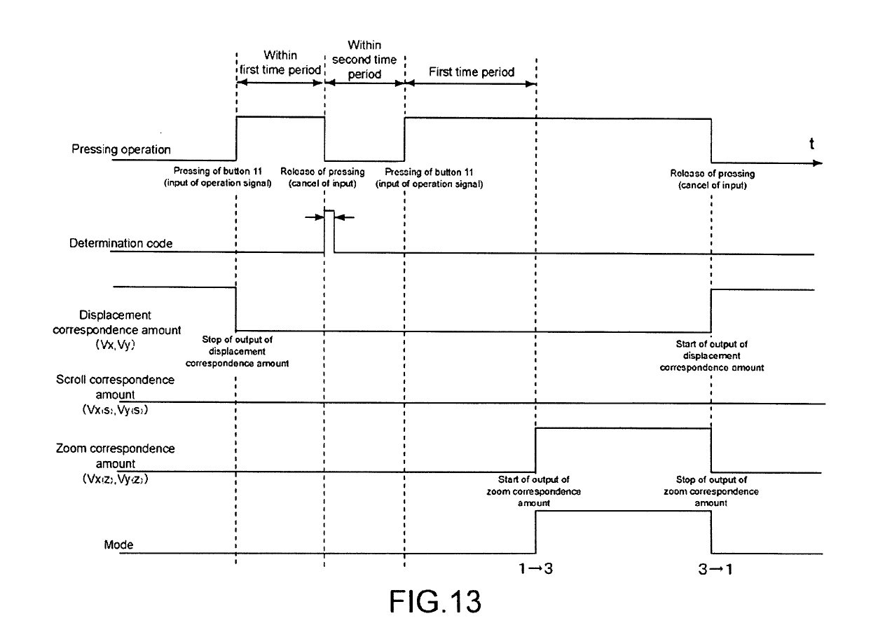

FIGS. 11 to 13 are timing charts for illustrating the operation shown in FIG. 10. FIG. 11 is a timing chart in a case where the user presses the button 11 and releases the pressing within a first time period. FIG. 12 is a timing chart in a case where the user press-and-holds the button 11 for a time period equal to or longer than the first time period. FIG. 13 is a timing chart in a case where, after the pressing of the button 11 is released within the first time period, the user re-presses the button 11 within a second time period and keeps pressing the button 11 for a time period equal to or longer than the first time period.

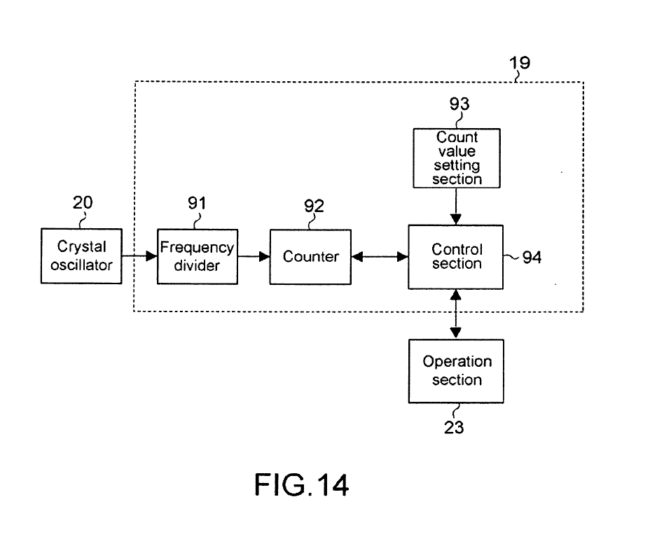

FIG. 14 is a functional block diagram of the input apparatus 1 for realizing the operation shown in FIG. 10. A frequency divider 91 shown in FIG. 14 generates clock pulses of a predetermined frequency based on pulses supplied from the crystal oscillator 20. A counter 92 counts the clock pulses generated by the frequency divider 91. A count value setting section 93 sets and stores a predetermined number of count values, for example. A control section 94 compares the count value supplied from the counter 92 and the count value supplied from the count value setting section 93 to judge whether the first time period or the second time period to be described later has passed.

The respective blocks of the frequency divider 91, the counter 92, the count value setting section 93, the control section 94, and the like are typically included in the MPU 19. The following descriptions will be given assuming that those blocks are included in the MPU 19 and processing of the control section 94 is carried out as processing of the MPU 19. However, instead of the MPU 19, those blocks may be included in a DSP (Digital Signal Processor), an FPGA (Field Programmable Gate Array), or the like.

A first count value corresponding to the first time period and a second count value corresponding to the second time period are stored in the count value setting section 93 in advance.

Typically, each of the first time period and the second time period is a time period within 0.2 to 0.4 sec, though not limited thereto. The time periods may be 0.2 sec or less or 0.4 sec or more.

Alternatively, the user may be allowed to customize the first time period and the second time period. For realizing such a customization by the user, the input apparatus 1 may be provided with a DIP switch or a variable resistor, for example. Moreover, the user may be allowed to customize the first time period and the second time period by operating a GUI on the screen 3 using the input apparatus 1 and the operation section 23.

Because the first time period and the second time period can be customized as described above, the user can arbitrarily set a first time period that matches the operational feeling of the user him/herself. As a result, an operational feeling in inputting an operation using the button 11 can be improved.

While referring to FIG. 11, descriptions will first be given on an operation of the input apparatus 1 carried out when the user presses the button 11 and releases the pressing within the first time period.

As shown in FIG. 10, when the button 11 is not pressed, the input apparatus 1 is outputting displacement correspondence amounts (Vₓ, V_{y}) (No in Step 201). When the user swings the input apparatus 1 in the yaw or pitch direction in this state, for example, the pointer 2 moves on the screen 3. It should be noted that in descriptions below, the state where the displacement correspondence amounts (velocity values) are output or a state where the displacement correspondence amounts can be output is referred to as first mode, a state where scroll correspondence amounts to be described later are output or can be output is referred to as second mode, and a state where zoom correspondence amounts to be described later are output or can be output is referred to as third mode.

When the button 11 is pressed by the user, a switch (not shown) generates an operation signal which is then input to the MPU 19 (Yes in Step 201). When an input of the operation signal from the switch is started, the MPU 19 stops outputting the displacement correspondence amounts (Step 202), or starts outputting the displacement correspondence amounts (Vₓ, V_{y}) set to 0. Accordingly, it becomes possible to prevent the pointer 2 from moving on the screen 3 when the casing 10 tilts due to the pressing of the button 11 by the user.

When the input of the operation signal is started, the MPU 19 judges whether the input of the operation signal from the switch has been canceled within the first time period since the start of the input (Step 203).

When the pressing of the button 11 is released within the first time period since the start of the input of the operation signal to thus cancel the input of the operation signal (Yes in Step 203), that is, when the user clicks the button 11, the MPU 19 outputs a determination code (determination command) as an operation command (Step 204).

The determination code is output from the transceiver 21 as, for example, a short-term pulse signal (see FIG. 11). When the user releases the pressing of the button 11 within the first time period, the mode is not switched and the scroll and zoom correspondence amounts are not output as shown in FIG. 11.

Upon receiving an input of the determination code output from the input apparatus 1, the control apparatus 40 executes predetermined processing. For example, when the pointer 2 is placed on the icon 4 on the screen 3 in FIG. 5 when the button 11 is pressed, the MPU 35 of the control apparatus 40 executes processing of selecting the icon 4 or activates an application program corresponding to the icon 4. When the pointer 2 is not placed on the icon 4 when the button 11 is pressed, the control apparatus 40 executes other predetermined processing.

Upon outputting the determination code, the MPU 19 judges whether an operation signal is input again within the second time period since the cancel of the input of the operation signal (Step 205). When judged that the second time period has passed (No in Step 205), the MPU 19 starts outputting the displacement correspondence amounts (Step 206).

When the button 11 is pressed and the pressing thereof is released within the first time period in the processing of Steps 201 to 206, the button 11 exhibits the function corresponding to a left button of a mouse, for example. By the user pressing the button 11 and releasing the pressing within the first time period (i.e., click), it is possible to carry out an operation of selecting an icon on the screen 3, for example.

Next, while referring to FIG. 12, descriptions will be given on an operation of the input apparatus 1 carried out when the user press-and-holds the button 11 for a time period equal to or longer than the first time period.

When the button 11 is pressed and the input of the operation signal is started (Yes in Step 201), the MPU 19 stops outputting the displacement correspondence amounts (Step 202) and judges whether the input of the operation signal is canceled within the first time period since the start of the input (Step 203). When the input of the operation signal is not canceled within the first time period (No in Step 203), that is, when the user press-and-holds the button 11 for a time period equal to or longer than the first time period, the MPU 19 switches the first mode to the second mode (Step 213) (mode switch means) and starts outputting the scroll correspondence amounts (Vₓ₍ₛ₎, V_{y(s)}) (Step 214) (see FIG. 12).

Upon receiving the input of the scroll correspondence amounts, the MPU 35 of the control apparatus 40 controls display such that, when the image 6 is active or the pointer 2 is placed inside the image 6 on the screen 3 in FIG. 5, the letters 7 are scrolled within the image 6 at a velocity corresponding to the scroll correspondence amounts, for example. It should be noted that although a scroll target to be scrolled is described to be the letters 7, the scroll target may instead be a still image or a moving image displayed inside the image 6. The same holds true for a zoom target to be zoomed.

Typically, the scroll correspondence amounts (Vₓ₍ₛ₎, V_{y(s)}) output in Step 214 are signals generated based on the displacement correspondence amounts. For example, the MPU 19 superimposes signals of a predetermined frequency on the signals of the displacement correspondence amounts (Vₓ, V_{y}) to thus generate the scroll correspondence amounts (Vₓ₍ₛ₎, V_{y(s)}), and outputs the signals from the transceiver 21. Accordingly, the MPU 35 of the control apparatus 40 distinguishably recognizes the displacement correspondence amounts and the scroll correspondence amounts, and switches the control from control of display of the movement of the pointer to control of display of the scroll of the image 6.

When the user swings the input apparatus 1 in the second mode, the letters 7 displayed inside the image 6 are scrolled at a velocity corresponding to a movement velocity of the input apparatus. For example, when the user swings the input apparatus 1 upwards from the reference position by turning a wrist thereof, the letters 7 inside the image 6 are scrolled in a positive direction of the Y axis on the screen 3. Alternatively, the control apparatus 40 may be caused to execute processing in which, when the user turns the wrist thereof in the upward direction, the letters 7 are scrolled in a negative direction of the Y axis on the screen 3. Meanwhile, when the user swings the input apparatus 1 in the yaw direction, the letters 7 are scrolled in the X-axis direction on the screen 3. Accordingly, simple and intuitional scroll operations of the image 6 for the user become possible.

Upon starting to output the scroll correspondence amounts when the button 11 is pressed and held for a time period equal to or longer than the first time period (Step 214), the MPU 19 judges whether the pressing of the button 11 is released and the input of the operation signal from the switch is thus canceled (Step 215). When the pressing of the button 11 is released and the input of the operation signal is canceled (Yes in Step 215), the MPU 19 stops outputting the scroll correspondence amounts (Step 216). Then the MPU 19 switches the mode from the second mode for outputting the scroll correspondence amounts to the first mode for outputting the displacement correspondence amounts (Step 217), and starts outputting the displacement correspondence amounts (Step 206). The determination code is not output when the user press-and-holds the button 11 for a time period equal to or longer than the first time period (see FIG. 12).

By the processing of Steps 201 to 203 and 213 to 217, the button 11 exhibits the function corresponding to a mode switch button for switching the first mode to the second mode and vise versa. The user can scroll the letters 7 inside the image 6 displayed on the screen 3 by 3-dimensionally operating the input apparatus 1 after press-and-holding the button 11 for a time period equal to or longer than the first time period.

Next, while referring to FIG. 13, descriptions will be given on an operation of the input apparatus 1 carried out when, after pressing of the button 11 is released within the first time period, the user re-presses the button 11 within the second time period and keeps pressing the button 11 for a time period equal to or longer than the first time period (hereinafter, referred to as special pressing operation).

When the pressing of the button 11 is released within the first time period since the start of the pressing thereof (Yes in Step 203), the MPU 19 outputs the determination code (Step 204) and judges whether the button 11 is re-pressed within the second time period since the pressing has been released (Step 205).

When the button 11 is re-pressed within the second time period and the operation signal is thus input (Yes in Step 205), the MPU 19 judges whether the re-pressing of the button 11 is released within the first time period (Step 207). When the re-pressing of the button 11 is released within the first time period and the input of the operation signal is thus canceled (Yes in Step 207), the MPU 19 returns to Step 204 and outputs the determination code. After receiving the input of the determination code, the MPU 35 of the control apparatus 40 may execute processing corresponding to a double-click when the determination code is input again within a predetermined time period.

On the other hand, when the button 11 is re-pressed and held for a time period equal to or longer than the first time period (No in Step 207), the MPU 19 switches the first mode for outputting the displacement correspondence amounts to the third mode (Step 208) (mode switch means) and starts outputting the zoom correspondence amounts (V_{x(z)}, V_{y(z)}) (Step 209) (see FIG. 13). In other words, when the user re-presses the button 11 within the second time period since the pressing of the button 11 is released within the first time period and keeps pressing the button 11 for a time period equal to or longer than the first time period (special pressing operation), the MPU 19 switches the first mode to the third mode.

Upon receiving the zoom correspondence amounts via the antenna 39 and the transceiver 38, the MPU 35 of the control apparatus 40 carries out control such that the letters 7 within the image 6 are zoomed in/out at a velocity corresponding to the zoom correspondence amounts.

Typically, the zoom correspondence amounts output in the third mode are signals generated based on the displacement correspondence amounts, that is, signals generated by superimposing signals of a predetermined frequency on the signals of the displacement correspondence amounts, for example.

When the user swings the input apparatus 1 in the third mode, the letters 7 displayed inside the image 6 are zoomed in/out at a velocity corresponding to the movement velocity of the input apparatus 1. For example, when the user swings the input apparatus 1 upwards from the reference position by turning the wrist, the letters 7 within the image 6 on the screen 3 are zoomed in. On the other hand, when the user swings the input apparatus 1 downwards from the reference position, the letters 7 within the image 6 are zoomed out. Accordingly, simple and intuitional zoom operations of the image 6 become possible for the user. It should be noted that also when the user swings the input apparatus 1 in the yaw direction, the letters 7 are zoomed in/out. A relationship between the operation direction of the input apparatus 1 and zoom in/out is set appropriately.

Upon starting to output the zoom correspondence amounts (Step 209), the MPU 19 judges whether the pressing of the button 11 is released (Step 210). When the pressing of the button 11 is released and the input of the operation signal is thus canceled (Yes in Step 210), the MPU 19 stops outputting the zoom correspondence amounts (Step 211). After that, the MPU 19 switches the third mode to the first mode and starts outputting the displacement correspondence amounts (Step 206).

By the processing of Steps 201 to 212, the button 11 exhibits the function corresponding to a mode switch button for switching the first mode to the third mode and vise versa, by the user carrying out the special pressing operation on the button 11. When the user operates the input apparatus 1 3-dimensionally after carrying out the special pressing operation on the button 11, the letters 7 within the image 6 displayed on the screen 3 are zoomed in/out.

By the processing as described above, through a simple pressing operation of the button 11 and 3-dimensional operation of the input apparatus 1, the user can, for example, input a selection, execution, and the like of the icon 4 (determination operation) and scroll and zoom the letters 7 within the image 6.

Moreover, in this embodiment, because the user can realize the operation of moving the pointer 2 and the scroll and zoom operations of the image 6 by the pressing operation using a single operation section (button 11) and the 3-dimensional operation of the input apparatus 1, it becomes possible to realize cost reductions since there is no need to additionally provide, for example, a wheel button as an operation section provided especially for realizing scroll and zoom operations, to the input apparatus.

When the button 11 is pressed and held for a time period equal to or longer than the first time period in Step 203 (No in Step 203) and the first mode is thus switched to the second mode (Step 213), the MPU 19 may output the displacement correspondence amounts and a signal for making the control apparatus 40 control display of the scroll (scroll display signal). In this case, signals of a predetermined frequency do not need to be superimposed on the displacement correspondence amounts (velocity values), and the displacement correspondence amounts and the scroll display signal are output from the input apparatus 1 in parallel from after the end of the first time period until the pressing of the button 11 is released. When the displacement correspondence amounts and the scroll display signal are received in parallel, the control apparatus 40 carries out control such that the letters 7 within the image 6 are scrolled. In this case, because the displacement correspondence amounts correspond to amounts to be scrolled, the scroll correspondence amounts correspond to the displacement correspondence amounts. In this specification, the expression “output the scroll correspondence amounts” also refers to a case where the displacement correspondence amounts and the scroll display signal are output in parallel. Alternatively, the MPU 19 may output, when the first mode is switched to the second mode (Step 213), a signal indicating the mode switch (mode switch signal). In this case, upon receiving the mode switch signal, the control apparatus 40 switches the display of the movement of the pointer to the display of the scroll of the image.

Similarly, when the first mode is switched to the third mode (Step 208), the MPU 19 may output the displacement correspondence amounts (velocity values) and a zoom display signal in parallel. In this specification, the expression “output the zoom correspondence amounts” also refers to a case where the displacement correspondence amounts and the zoom display signal are output in parallel. Alternatively, the MPU 19 may output, when the first mode is switched to the third mode (Step 208), a signal indicating the mode switch (mode switch signal). In this case, upon receiving the mode switch signal, the control apparatus 40 switches the display of the movement of the pointer to the display of the zoom of the image.

In this embodiment, descriptions have been given on the case where the input apparatus 1 operates in the first mode when not input with an operation signal, switches from the first mode to the second mode when the button 11 is pressed and held for a time period equal to or longer than the first time period, and switches from the first mode to the third mode when a special pressing operation is made on the button 11. However, it is also possible that the input apparatus 1 operates in the second or third mode when not input with the operation signal. Moreover, the modes to be switched by the pressing operation to the button 11 can be changed appropriately.

The descriptions above have been given on the case where, when the input of the operation signal is canceled within the first time period, the determination code is output immediately after the input of the operation signal is canceled (see Step 204 and FIGS. 11 and 13). However, the present application is not limited thereto, and the MPU 19 may output, in the case where the input of the operation signal is canceled within the first time period, the determination code when the operation signal is not input within the second time period since the cancel of the input of the last operation signal.

The mode switch processing shown in FIG. 10 may be executed by the control apparatus 40. In this case, the MPU 35 of the control apparatus 40 receives information on the displacement correspondence amounts and a pressing signal (e.g., pressing code) as information on the operation of the button 11 that have been output from the input apparatus 1. When not input with the pressing signal, the MPU 35 of the control apparatus 40 causes the pointer 2 to move on the screen 3 in accordance with the received displacement correspondence amounts. When an input of the pressing signal is started, the MPU 35 stops moving the pointer 2. When the pressing signal keeps being input for a time period equal to or longer than the first time period since the start of the input, the first mode for controlling the display such that the pointer 2 moves on the screen 3 is switched to the second mode for controlling the display such that the image 6 is scrolled (mode switch means). Then, the MPU 35 controls display such that the image 6 is scrolled at a scroll velocity value corresponding to the received displacement correspondence amounts until the input of the pressing signal is canceled. When the input of the pressing signal is canceled within the first time period since the start of the input and the pressing signal is started to be input again within the second time period and keeps being input for a time period equal to or longer than the first time period, the first mode is switched to the third mode for controlling the display so as to zoom in/out on the image 6. In the third mode, the MPU 35 controls the display such that the image 6 is zoomed in/out at a zoom velocity value corresponding to the displacement correspondence amounts. Also in processing of embodiments to be described later, the control apparatus 40 may execute the mode switch processing. It should be noted that the displacement correspondence amounts (velocity values) may be calculated by the control apparatus 40.

Next, descriptions will be given on the input apparatus 1 according to another embodiment. In descriptions below, parts having the same structures and functions as those of the above embodiment are denoted by the same reference numerals, and descriptions thereof will be omitted or simplified.

The input apparatus 1 shown in FIGS. 1 to 14 makes a switch among the first to third modes in accordance with whether the button 11 has been pressed and how the button 11 has been pressed. However, the input apparatus 1 according to this embodiment is different from that shown in FIGS. 1 to 14 in that when the button 11 is pressed and held, the modes are switched successively every time a predetermined cycle time period passes, and the input apparatus 1 includes an LED display section for visually indicating a mode status thereof.

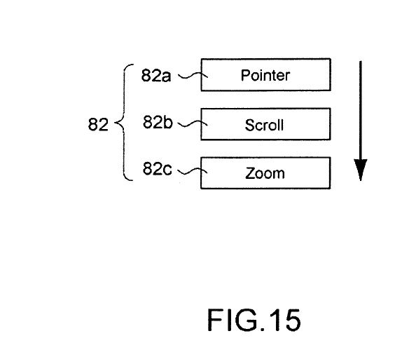

FIG. 15 is a schematic diagram showing the LED display section included in the input apparatus 1 according to this embodiment. An LED display section 82 may be disposed anywhere on the casing 10 as long as it can be easily viewed by the user. The LED display section 82 includes a first display section 82a that is lit in the first mode, a second display section 82b that is lit in the second mode, and a third display section 82c that is lit in the third mode. By the LED display section 82, the user is capable of visually checking the mode of the input apparatus 1 at that time. It should be noted that instead of the LED display section 82 provided on the casing 10, GUIs as shown in FIG. 15 may be displayed on the screen 3.

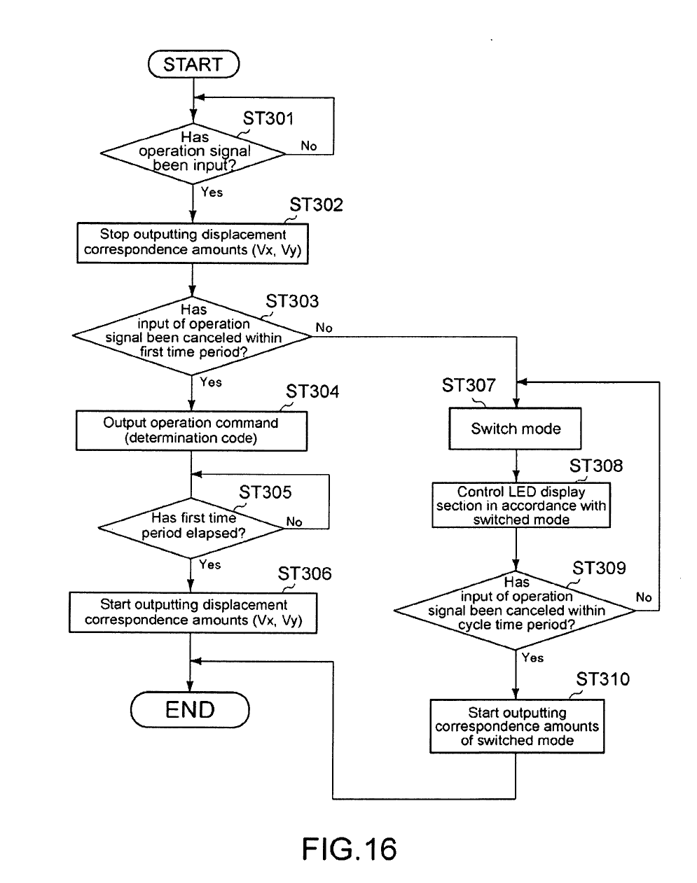

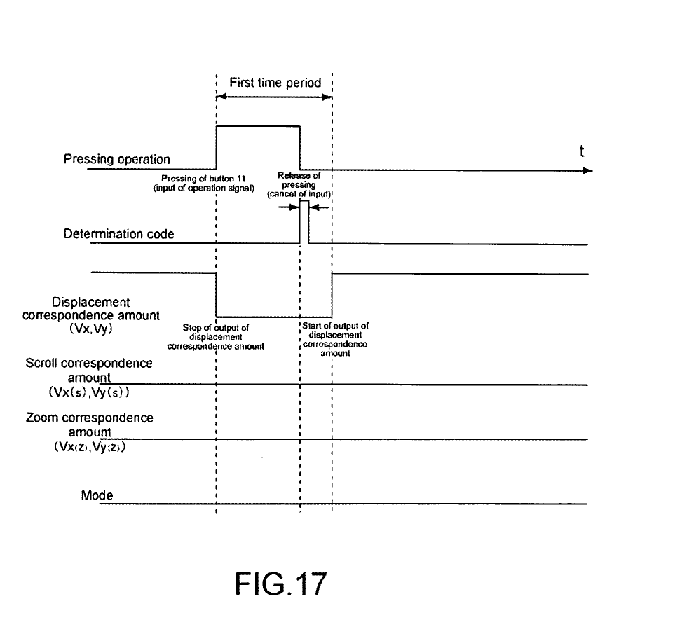

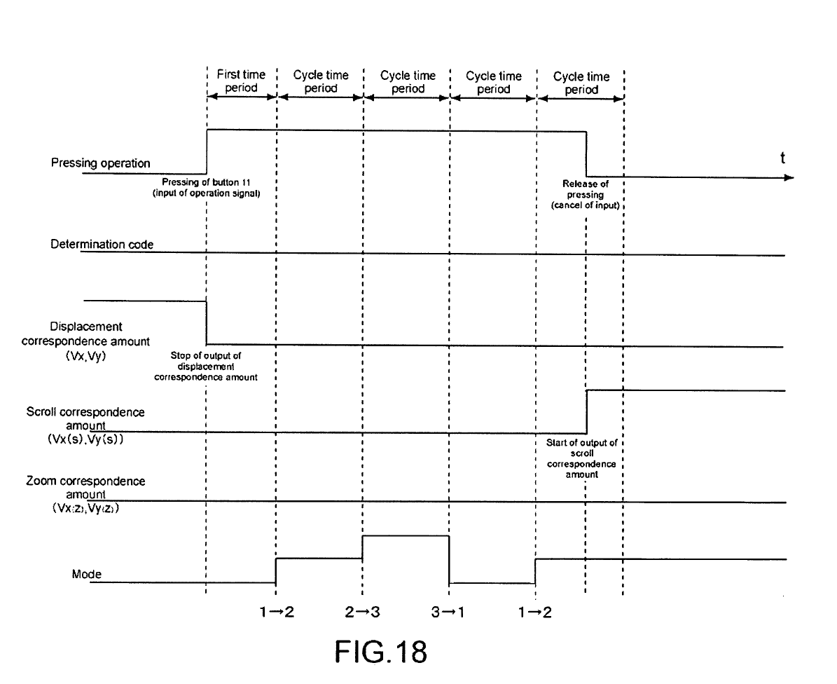

FIG. 16 is a flowchart showing an operation of the input apparatus 1 according to this embodiment. FIGS. 17 and 18 are timing charts for illustrating the operation shown in FIG. 16. FIG. 17 is a timing chart in a case where the pressing of the button 11 is released within the first time period, and FIG. 18 is a timing chart in a case where the button 11 is pressed and held for a time period equal to or longer than the first time period.

For realizing the operation shown in FIG. 16, a third count value corresponding to the cycle time period is stored in the count value setting section 93 shown in FIG. 14, for example. The third time period typically is a time within 0.8 sec to 1.2 sec, though not limited thereto. The time may be 0.8 sec or less or 1.2 sec or more.

As shown in FIG. 16, when the button 11 is not pressed and the operation signal is thus not input (No in Step 301), the mode is the first mode, and the MPU 19 is outputting the displacement correspondence amounts. In addition, the MPU 19 is controlling the LED display section 82 so that the first display section 82a is lit.

When the button 11 is pressed and the operation signal is input (Yes in Step 301), the MPU 19 stops outputting the displacement correspondence amounts (Step 302), and when the input of the operation signal is canceled within the first time period (Yes in Step 303), the MPU 19 outputs a determination code (Step 304) (see FIG. 17). In other words, the button 11 exhibits the function corresponding to the determination button by being clicked by the user.

The MPU 19 judges whether the first time period has passed since the start of the input of the operation signal (Step 305), and when the first time period has passed (Yes in Step 305), starts outputting the displacement correspondence amounts (Step 306) (see FIG. 17). As described above, by outputting the displacement correspondence amounts after the first time period has passed since the start of the input of the operation signal, it becomes possible to prevent processing unintended by the user from being executed on the screen 3 when the casing 10 tilts, after the pressing of the button 11 is released.

Meanwhile, when the input of the operation signal is not canceled within the first time period since the start of the input of the operation signal (No in Step 303), that is, when the user press-and-holds the button 11 for a time period equal to or longer than the first time period, the MPU 19 switches the first mode to the second mode (Step 307). In this case, even when the first mode is switched to the second mode, the MPU 19 does not immediately output the scroll correspondence amounts and remains in a state capable of outputting the scroll correspondence amounts (see FIG. 18).

Upon switching the first mode to the second mode, the MPU 19 controls the LED display section 82 such that the light of the first display section 82a is turned off and the second display section 82b is lit (Step 308).

The MPU 19 then judges whether a predetermined cycle time period has passed since the end of the first time period from after the start of the pressing of the button 11, and judges whether the pressing of the button 11 has been released within the cycle time period and the input of the operation signal has thus been canceled (Step 309).

When the input of the operation signal is not canceled within the cycle time period after the first time period has passed since the start of the input of the operation signal (No in Step 309), the MPU 19 switches the second mode to the third mode (Step 307). Also in this case, the MPU 19 does not immediately output the zoom correspondence amounts (see FIG. 18).

Upon switching the second mode to the third mode, the MPU 19 controls the LED display section 82 such that the light of the second display section 82b is turned off and the third display section 82c is lit (Step 308).

Then, the MPU 19 again judges whether the input of the operation signal is canceled within the cycle time period since the end of the last cycle time period (Step 309), and when the input of the operation signal is not canceled (No in Step 309), switches the third mode to the first mode (Step 307). Then, the MPU 19 controls the LED display section 82 such that the light of the third display section 82c is turned off and the first display section 82a is lit (Step 308).

When the user thus press-and-holds the button 11, the MPU 19 switches the first to third modes successively for each cycle time period.

Meanwhile, when the pressing of the button 11 is released within the cycle time period and the input of the operation signal is thus canceled (Yes in Step 309), the MPU 19 starts outputting the displacement correspondence amounts, the scroll correspondence amounts, or the zoom correspondence amounts in accordance with the mode at that time. In the example of FIG. 18, since the pressing of the button 11 is released during the second mode, the MPU 19 starts outputting the scroll correspondence amounts.

By the operation shown in FIG. 16, the button 11 exhibits, for example, the function corresponding to a left button of a mouse (determination button) and the function corresponding to a mode switch button for switching the first, second, or third mode to the other one of the three modes.

By releasing the pressed button 11 within the first time period, the user is capable of selecting an icon on the screen 3, and by merely press-and-holding the button 11, the user is capable of switching one of the first to third modes to the other one of the three modes. Further, in this embodiment, because the operation of moving the pointer and the scroll and zoom operations are realized by the pressing operation using a single operation section and the 3-dimensional operation of the input apparatus 1, it becomes possible to realize cost reductions since there is no need to additionally provide, for example, a wheel button as an operation section provided especially for realizing scroll and zoom, to the input apparatus.

Although this embodiment has described the case where the modes are switched in the stated order of the first mode, the second mode, the third mode, the first mode, and so on, the order in which the modes are switched may be in the stated order of the first mode, the third mode, the second mode, the first mode, and so on. Moreover, in this embodiment, the mode in which the operation signal is not input has been described as the first mode. However, the mode in which the operation signal is not input may be the second mode or the third mode instead.

Next, descriptions will be given on the input apparatus 1 according to another embodiment.

The input apparatus 1 according to this embodiment is different from those shown in FIGS. 1 to 18 in that the input apparatus 1 according to this embodiment includes an operation section with a so-called 2-step switch for switching the modes.

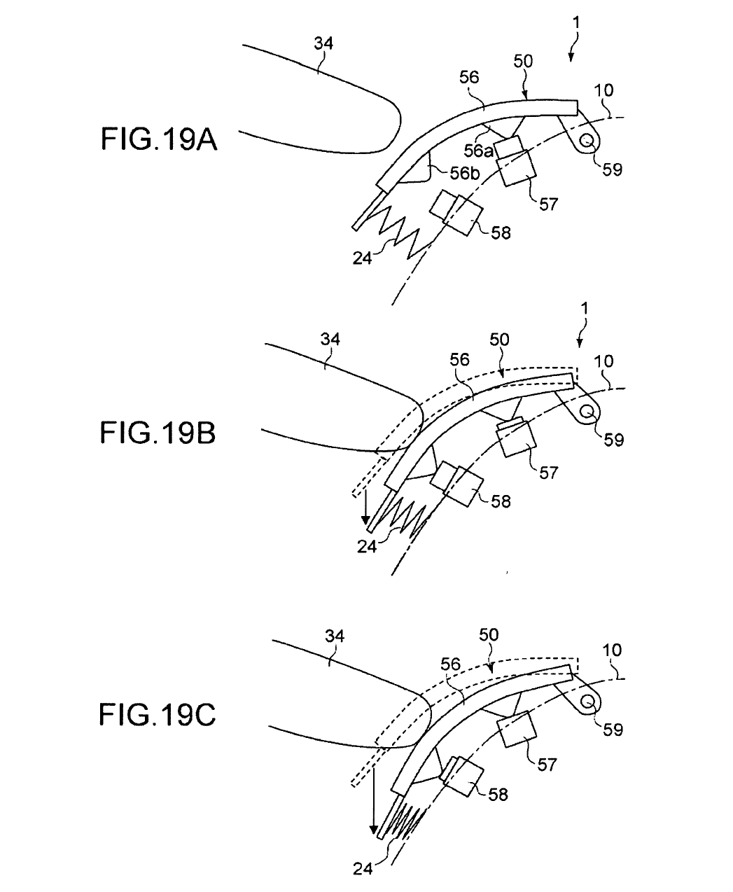

FIGS. 19A to 19C are schematic diagrams showing the operation section included in the input apparatus 1 according to this embodiment. An operation section 50 included in the input apparatus 1 according to this embodiment has a function corresponding to a determination button. Therefore, for maintaining the function as the determination button, which is the original function of the button 11 shown in FIG. 6, the operation section 50 is typically disposed apart from the button 11 at a position on a side surface of the casing 10 where the user is capable of operating with a thumb (see FIG. 6). However, the position of the operation section 50 is not limited thereto and may be disposed where the button 11 or 12 shown in FIG. 6 is disposed, or elsewhere on the casing 10.

The operation section 50 is a press-type button having a 2-step action. The operation section 50 includes, for example, a first button 57, a second button 58 disposed physically apart from the first button 57, and a surface button 56 capable of successively pressing the first button 57 and the second button 58. The first button 57 has a built-in switch (first switch) (not shown) and the second button 58 also has a built-in switch (second switch) (not shown). When the first button 57 is pressed and the first switch is turned on, the first switch starts generating a first operation signal and outputs the signal to the MPU 19. On the other hand, when the second button 58 is pressed and the second switch is turned on, the second switch starts generating a second operation signal and outputs the signal to the MPU 19. The switches of the first button 57 and the second button 58 are electrically connected to the main substrate 18.

FIG. 19A is a diagram showing a state where the operation section 50 is not pressed by the user. The surface button 56 is connected to a shaft 59 provided on the casing 10 and is connected to the casing 10 at an end portion thereof opposite to the shaft 59 via a spring 24. By the user pressing a surface of the surface button 56 by a finger 34, the surface button 56 rotates about the shaft 59 against a spring force of the spring 24. The first button 57 and the second button 58 are each a push button. The surface button 56 is provided with, on a back surface thereof, protrusions 56a and 56b capable of respectively pressing the first button 57 and the second button 58.

The first button 57 and the second button 58 are provided so as to be exposed from the surface of the casing 10 from inside the casing 10, for example. When the surface button 56 is pressed a predetermined distance (first distance) (see FIG. 19B), the first button 57 is pressed by the protrusion 56a, and when the surface button 56 is subsequently pressed an additional predetermined distance (second distance) (see FIG. 19C), the second button 58 is pressed by the protrusion 56b. FIG. 19B shows a state where the first button 57 is pressed but the second button 58 is not pressed. FIG. 19C shows a state where both the first button 57 and the second button 58 are pressed.

When releasing the pressed surface button 56, the surface button 56 moves as shown in the stated order of FIG. 19C, FIG. 19B, and FIG. 19A. Specifically, the second button 58 is released first and the first button 57 is released thereafter.

The first distance and the second distance may be the same (or may be different), and the distances can be set appropriately. A force required to shift the state from the state shown in FIG. 19A to that shown in FIG. 19B may be the same as a force required to shift the state from the state shown in FIG. 19B to that shown in FIG. 19C.

With the operation section 50 structured as described above, a so-called halfway pressing that maintains a state where the first button 57 is pressed but the second button 58 is not (FIG. 19B) is also possible.

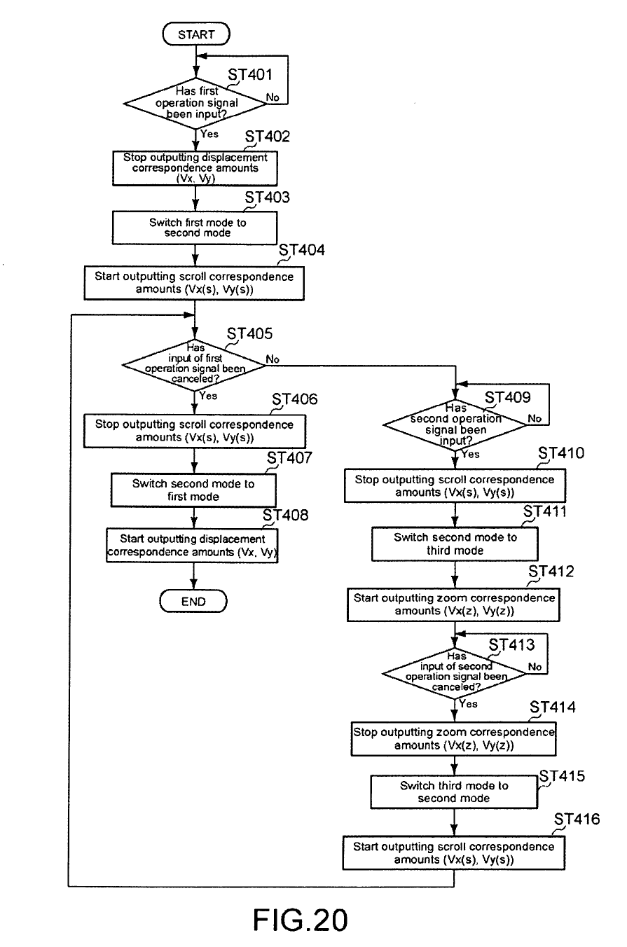

Next, descriptions will be given on an operation of the input apparatus 1 including the operation section 50. FIG. 20 is a flowchart showing the operation of the input apparatus 1 according to this embodiment.

As shown in FIG. 20, in a state where the first button 57 is not pressed and the first operation signal is thus not input to the MPU 19, the mode is the first mode and the MPU 19 is outputting the displacement correspondence amounts (Vₓ, V_{y}) (No in Step 401).

When the user presses the surface button 56 halfway (see FIG. 19B), the first button 57 is pressed accordingly and the first operation signal from the first switch is thus input (Yes in Step 401). The MPU 19 then stops outputting the displacement correspondence amounts (Step 402) and switches the first mode to the second mode (Step 403). After switching the first mode to the second mode, the MPU 19 starts outputting the scroll correspondence amounts (Step 404). In other words, in this embodiment, the first button 57 exhibits the function corresponding to a mode switch button for switching the first mode to the second mode and vise versa.

When the user swings the input apparatus 1 while pressing the surface button 56 halfway, the letters 7 within the image 6 on the screen 3 are scrolled.

Upon start of the output of the scroll correspondence amounts (Vₓ₍ₛ₎, V_{y(s)}), the MPU 19 judges whether the input of the first operation signal has been canceled (Step 405). When the user releases the finger 34 from the surface button 56 (see FIG. 19A) and the input of the first operation signal is thus canceled (Yes in Step 405), the MPU 19 stops outputting the scroll correspondence amounts (Vₓ₍ₛ₎, V_{y(s)}) (Step 406).

After that, the MPU 19 switches the second mode to the first mode (Step 407) and starts outputting the displacement correspondence amounts (Step 408).

Meanwhile, when the input of the first operation signal is not canceled (No in Step 405) and the second operation signal is input while the first operation signal is still being input (Yes in Step 409), that is, when the user presses the surface button 56 by the second distance, the MPU 19 stops outputting the scroll correspondence amounts (Step 410).

Upon stopping the output of the scroll correspondence amounts, the MPU 19 switches the second mode to the third mode (Step 411) and starts outputting the zoom correspondence amounts (V_{x(z)}, V_{y(z)}) (Step 412). In other words, in this embodiment, the second button 58 exhibits the function corresponding to a mode switch button for switching the second mode to the third mode and vise versa.

When the user swings the input apparatus 1 while still pressing the surface button 56 by the second distance, if the image 6 displayed on the screen 3 is active, the letters 7 within the image 6 are zoomed in/out.

Upon start of the output of the zoom correspondence amounts, the MPU 19 judges whether the input of the second operation signal has been canceled (Step 413). When the surface button 56 is pressed halfway (see FIG. 19B) and the input of the second operation signal from the second switch is thus canceled (Yes in Step 413), the MPU 19 stops outputting the zoom correspondence amounts (Step 414). After that, the MPU 19 switches the third mode to the second mode (Step 415) and starts outputting the scroll correspondence amounts (Step 416). Then, the MPU 19 again judges whether the input of the first operation signal has been canceled (Step 405).

By the processing shown in FIG. 20, the user can successively make a switch between the first button capable of switching the first mode to the second mode and vise versa and the second button capable of switching the second mode to the third mode and vise versa. Accordingly, an intuitional operation becomes possible.

The modes to be switched in Steps 403 and 407 and the modes to be switched in Steps 411 and 415 can be changed. For example, the modes to be switched in Steps 403 and 407 may be the first mode and the third mode, and the modes to be switched in Steps 411 and 415 may be the first mode and the second mode.

Next, descriptions will be given on the input apparatus 1 according to another embodiment.

The input apparatus 1 according to this embodiment is different from that shown in FIGS. 1 to 20 in that the input apparatus 1 according to this embodiment includes an operation section provided with a rotary section (lever) for switching modes.

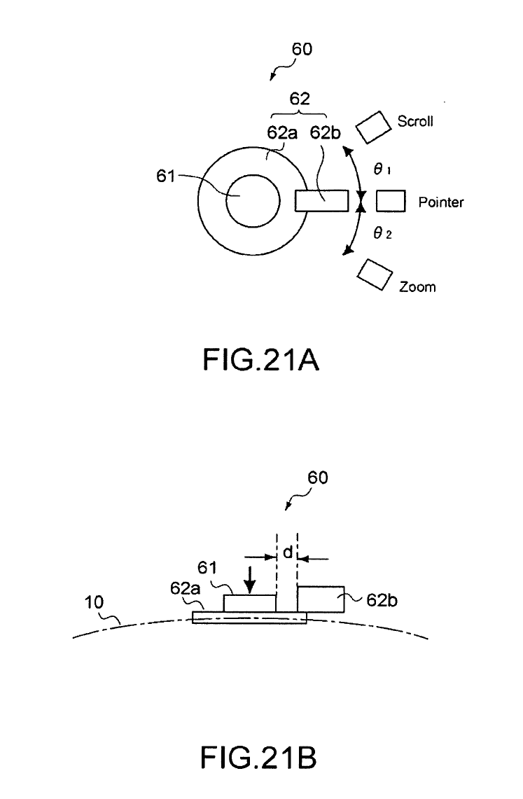

FIG. 21 are schematic diagrams showing an operation section 60 included in the input apparatus 1 according to this embodiment. FIG. 21 A is a top view of the operation section 60 and FIG. 21B is a side view thereof. The operation section 60 is typically disposed at a position of the button 11 on the casing 10 (see FIG. 6), though not limited thereto. The operation section 60 may instead be disposed at a position of the button 12 or at a position on the side surface of the casing 10 where the user is capable of operating with a thumb.

As shown in FIG. 21, the operation section 60 includes a press-type button 61 positioned at a center thereof and a rotary section 62 provided on a circumference of the button 61 and rotatable about an axis extending in a pressing direction of the button 61. The rotary section 62 includes a rotary section main body 62a and a lever-type rotary operation section 62b extending in a centrifugal direction from the rotary section 62. The button 61 has a built-in switch (not shown), and the rotary section 62 has a built-in rotary switch (not shown).

When not pressed by the user, the button 61 protrudes upward from the rotary section main body 62a. The button 61 moves upward or downward in accordance with the pressing operation of the user. Similarly, the rotary operation section 62b protrudes upward from the rotary section main body 62a, and the user is capable of rotating the rotary operation section 62b with a finger. The rotary section 62 can perform a 3-step rotation in accordance with the rotational operation made on the rotary operation section 62b by the user.

The button 61 and the rotary operation section 62b are disposed apart from each other by a predetermined distance d. Accordingly, it becomes possible to prevent the button 61 from being erroneously pressed when rotating the rotary operation section 62b.

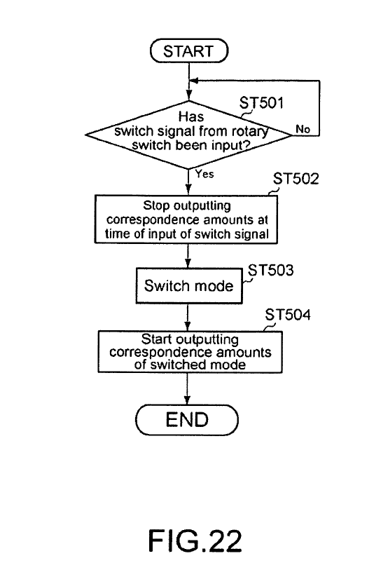

Next, descriptions will be given on an operation of the input apparatus 1 including the operation section 60 shown in FIG. 21. FIG. 22 is a flowchart showing an operation carried out when the rotary operation section 62b is rotated.

When the rotary operation section 62b is at a position shown in FIG. 21A (hereinafter, referred to as reference position), the input apparatus 1 is in the first mode and the MPU 19 is outputting the displacement correspondence amounts. When the user rotates the rotary operation section 62b from the reference position with a finger and the rotary operation section 62b is thus rotated by an angle θ₁, the rotary switch generates a switch signal and outputs the signal to the MPU 19. When input with the switch signal from the rotary switch (Yes in Step 501), the MPU 19 stops outputting the displacement correspondence amounts as correspondence amounts at the time of the input of the switch signal (Step 502). The MPU 19 then switches the first mode to the second mode (Step 503) and starts outputting the scroll correspondence amounts in the second mode (Step 504).

When the user rotates the rotary operation section 62b by the angle θ₁ to bring it back to its reference position, a switch signal is input to the MPU 19 (Yes in Step 501). Upon input of the switch signal, the MPU 19 stops outputting the scroll correspondence amounts (Step 502). After that, the MPU 19 switches the second mode to the first mode (Step 503) and starts outputting the displacement correspondence amounts (Step 504).

When the user rotates the rotary operation section 62b at its reference position by an angle θ₂, the MPU 19 stops outputting the displacement correspondence amounts (Steps 501 and 502). Then, the MPU 19 switches the first mode to the third mode (Step 503) and starts outputting the zoom correspondence amounts (Step 504). When the user rotates the rotary operation section 62b by the angle θ₂ to bring it back to its reference position, a switch signal is input to the MPU 19 (Yes in Step 501). Upon input of the switch signal, the MPU 19 stops outputting the zoom correspondence amounts (Step 502). After that, the MPU 19 switches the third mode to the first mode (Step 503) and starts outputting the displacement correspondence amounts (Step 504).

When the user presses the button 61, the built-in switch of the button 61 generates an operation signal in accordance with the pressing, and outputs the signal to the MPU 19. Upon input of the operation signal from the switch, the MPU 19 outputs a determination code. In other words, the button 61 exhibits the function as a determination button.

By the processing as described above, the user can select the icon 4 on the screen 3 or switch modes among the first to third modes, by a simple operation using only one finger, for example.

The MPU 19 may mutually switch the first mode and the third mode in accordance with the rotation of the rotary operation section 62b by the angle θ₁, or mutually switch the second mode and the third mode in accordance with the rotation by the angle θ₂. Alternatively, the mode at the time when the rotary operation section 62b is at the reference position may either be the second mode or the third mode.

The MPU 19 may control the outputs of the correspondence amounts in the first to third modes in accordance with the operation signal input from the switch when the button 61 is pressed. In this case, the MPU 19 outputs the correspondence amounts only when the button 61 is pressed and the operation signal from the switch is thus input during any of the first to third modes. Alternatively, the MPU 19 may output the correspondence amounts only when the button 61 is not pressed and the input of the operation signal from the switch is thus being canceled. By the processing as described above, the button 61 exhibits functions as a movement control button for controlling start/stop of the movement of the pointer 2, a scroll control button for controlling start/stop of scroll, and a zoom control button for controlling start/stop of zoom.

Accordingly, the user can control start/stop of the movement of the pointer, scroll, and zoom by a simple pressing operation. Furthermore, by releasing the finger pressing the button 61 and rotating the rotary operation section 62b, the user can easily switch modes among the first to third modes.

Next, descriptions will be given on the input apparatus 1 according to another embodiment.

The input apparatus 1 according to this embodiment realizes the same functions as that described above by provision of a sliding operation section instead of the rotary-type operation section 60 shown in FIG. 21.

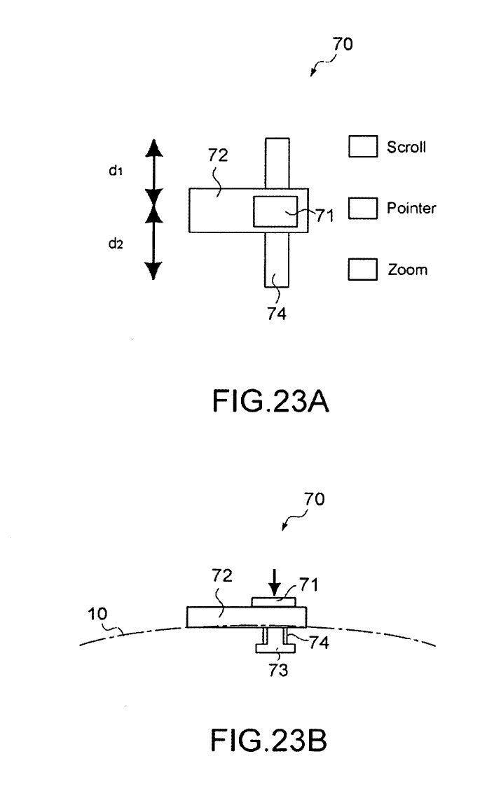

FIG. 23 are schematic diagrams showing an operation section 70 included in the input apparatus 1 according to this embodiment. FIG. 23A is a top view of the operation section 70 and FIG. 23B is a side view thereof. Typically, the operation section 70 is disposed at the position of the button 11 on the casing 10 (see FIG. 6), though not limited thereto. The operation section 70 may alternatively be disposed at the position of the button 12 or at a position on the side surface of the casing 10 where the user is capable of operating with a thumb.

As shown in FIG. 23, the operation section 70 is constituted of an engagement section 73 that engages with a groove 74 formed on the casing 10, the engagement section 73 being slidable on the groove 74, and an operation section main body 72 including a press-type button 71 and provided on the engagement section 73. The operation section 70 performs a 3-step slide in accordance with a sliding operation made to the operation section main body 72 by the user. Inside the casing 10, a slide switch for generating a switch signal in accordance with the 3-step slide of the operation section 70 is provided. Moreover, the button 71 has a built-in switch.

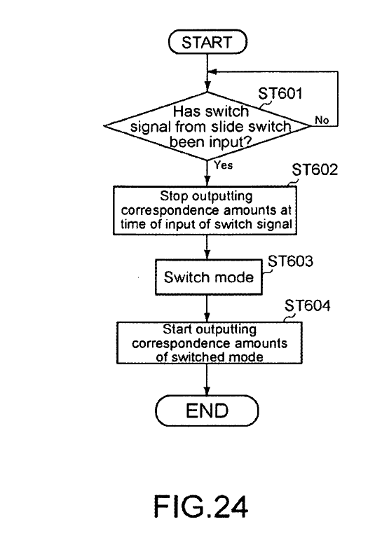

Next, descriptions will be given on an operation of the input apparatus 1 including the operation section 70 shown in FIG. 23. FIG. 24 is a flowchart showing an operation carried out when the operation section main body 72 is slid.

For example, when the operation section main body 72 is positioned at a center of the operation section 70 as shown in FIG. 23A (hereinafter, referred to as reference position), the input apparatus 1 is in the first mode, and the MPU 19 is outputting the displacement correspondence amounts. When the user slides the operation section main body 72 from the reference position with a finger and the operation section main body 72 is thus slid by a distance d₁, the slide switch generates a switch signal and outputs the signal to the MPU 19. When input with the switch signal from the slide switch (Yes in Step 601), the MPU 19 stops outputting the displacement correspondence amounts as correspondence amounts at the time of the input of the switch signal (Step 602). The MPU 19 then switches the first mode to the second mode (Step 603) and starts outputting the scroll correspondence amounts (Step 604).

When the user slides the operation section main body 72 by the distance d₁ to bring it back to its reference position, a switch signal is input to the MPU 19 (Yes in Step 601). Upon input of the switch signal, the MPU 19 stops outputting the scroll correspondence amounts (Step 602). After that, the MPU 19 switches the second mode to the first mode (Step 603) and starts outputting the displacement correspondence amounts (Step 604).

When the user slides the operation section main body 72 from its reference position by a distance d₂, the MPU 19 stops outputting the displacement correspondence amounts (Steps 601 and 602). Then, the MPU 19 switches the first mode to the third mode (Step 603) and starts outputting the zoom correspondence amounts (Step 604). When the user slides the operation section main body 72 by the distance d₂ to bring it back to its reference position, a switch signal is input to the MPU 19 (Yes in Step 601). Upon input of the switch signal, the MPU 19 stops outputting the zoom correspondence amounts (Step 602). After that, the MPU 19 switches the third mode to the first mode (Step 603) and starts outputting the displacement correspondence amounts (Step 604).

When the user presses the button 71, the built-in switch of the button 71 generates an operation signal in accordance with the pressing, and outputs the signal to the MPU 19. Upon input of the operation signal from the switch, the MPU 19 outputs a determination code. In other words, the button 71 exhibits the function as a determination button.

By the processing as described above, the user can select the icon 4 on the screen 3 or switch modes among the first to third modes, by a simple operation using only one finger, for example.

The MPU 19 may mutually switch the first mode and the third mode in accordance with the slide of the operation section main body 72 by the distance d₁, or mutually switch the second mode and the third mode in accordance with the slide by the distance d₂. Alternatively, the mode at the time when the operation section main body 72 is at the reference position may either be the second mode or the third mode.

The MPU 19 may control the outputs of the correspondence amounts in the first to third modes in accordance with the operation signal input from the switch when the button 71 is pressed. In this case, the MPU 19 outputs the correspondence amounts only when the button 71 is pressed and the operation signal from the switch is thus input during any of the first to third modes. Alternatively, the MPU 19 may output the correspondence amounts only when the button 71 is not pressed and the input of the operation signal from the switch is thus being canceled. By the processing as described above, the button 71 exhibits functions as a movement control button for controlling start/stop of the movement of the pointer 2, a scroll control button for controlling start/stop of scroll, and a zoom control button for controlling start/stop of zoom.

Accordingly, the user can control start/stop of the movement of the pointer, scroll, and zoom by a simple pressing operation.

It should be noted that the button 71 having the functions of the control buttons may be provided separate from the operation section main body 72 on the casing 10.

Next, descriptions will be given on the input apparatus 1 according to another embodiment.

The input apparatus 1 according to this embodiment is different from that shown in FIGS. 1 to 24 in that the input apparatus 1 according to this embodiment includes a button dedicated to mode switching, which is capable of switching modes every time the button is pressed.

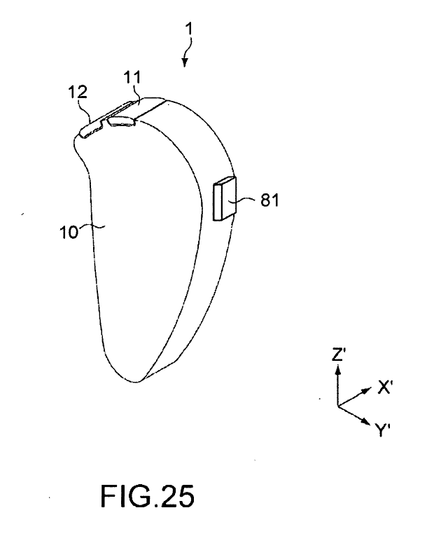

FIG. 25 is a perspective diagram of the input apparatus 1 according to this embodiment. As shown in FIG. 25, in this embodiment, in addition to the buttons 11 and 12, a button 81 is disposed at a position on the side surface of the casing 10 where the user is capable of operating with a thumb (see FIG. 6), though not limited thereto. The button 81 may be disposed at other positions on the casing 10. The button 81 has a built-in switch (not shown).

In addition to the button 81, the casing 10 is provided with the LED display section 82 as shown in FIG. 15. The LED display section 82 may be disposed anywhere on the casing 10 as long as it can be easily seen by the user. Alternatively, instead of providing the LED display section 82 on the casing 10, GUIs in a form as shown in FIG. 15 may be displayed on the screen 3.

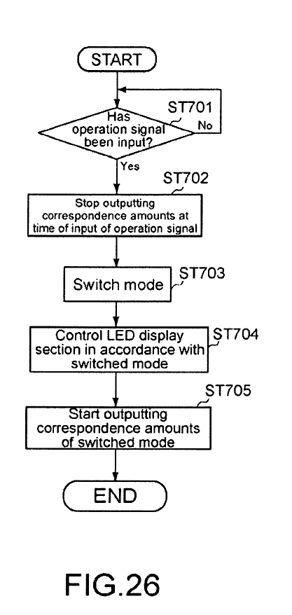

FIG. 26 is a flowchart showing an operation of the input apparatus 1 according to this embodiment.

For example, when the input apparatus 1 is in the first mode in a state where the operation signal is not input (No in Step 701), the MPU 19 is outputting the displacement correspondence amounts and controlling the LED display section 82 such that the first display section 82a is lit. When the button 81 is pressed and the operation signal is thus input (Yes in Step 701), the MPU 19 stops outputting the displacement correspondence amounts as correspondence amounts at the time of input of the operation signal (Step 702), and switches the first mode to the second mode (Step 703). Then, the MPU 19 controls the LED display section 82 such that the light of the first display section 82a is turned off and the second display section 82b is lit (Step 704), and starts outputting the scroll correspondence amounts (Step 705).

When the input apparatus 1 is in the second mode in a state where the operation signal is not input, the MPU 19 stops, upon input of the operation signal (Yes in Step 701), outputting the scroll correspondence amounts (Step 702) and switches the second mode to the third mode (Step 703). Then, the MPU 19 controls the LED display section 82 such that the third display section 82c is lit (Step 704) and starts outputting the zoom correspondence amounts (Step 705).

Similarly, when the input apparatus 1 is in the third mode in a state where the operation signal is not input, the MPU 19 switches, upon input of the operation signal, the third mode to the first mode and starts outputting the displacement correspondence amounts (Steps 701 to 705).

As described above, every time the button 81 is pressed, the MPU 19 switches the modes in the stated order of the first mode, the second mode, the third mode, the first mode, and so on. In other words, the button 81 is a mode switch button dedicated to the mode switching. Accordingly, the user can successively switch modes among the first to third modes by a simple pressing operation using the button 81.

The MPU 19 may switch the modes in the stated order of the first mode, the third mode, the second mode, the first mode, and so on, or switch modes among the first to third modes every time the user releases the pressing of the button 81 and the input of the operation signal is thus canceled.

Next, descriptions will be given on processing of the input apparatus 1 according to another embodiment.

In the embodiment shown in FIGS. 25 and 26, the input apparatus 1 switches the mode every time the button 81 is pressed. However, in this embodiment, in a case where the button 81 is pressed and held, the input apparatus 1 successively switches modes every time a predetermined cycle time period passes. This embodiment mainly describes points different from that of the embodiment shown in FIGS. 25 and 26.

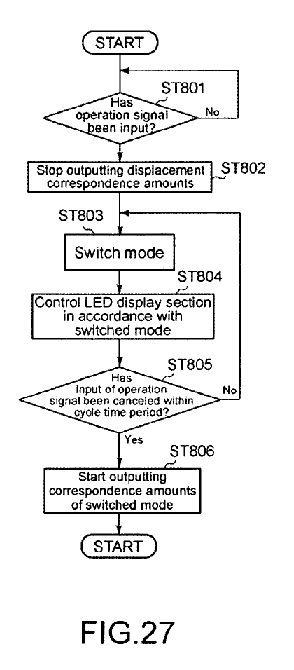

FIG. 27 is a flowchart showing an operation of the input apparatus 1 according to this embodiment. For realizing the operation shown in FIG. 27, a third count value corresponding to the cycle time period is stored in the count value setting section 93 shown in FIG. 14, for example. The third time period is typically a time within 0.8 sec to 1.2 sec, though not limited thereto. The time may be less than 0.8 sec or more than 1.2 sec.

When the button 81 is not pressed and the operation signal from the switch of the button 81 is thus not input, the input apparatus 1 is in the first mode, and the MPU 19 is outputting the displacement correspondence amounts (No in Step 801). In addition, the MPU 19 is controlling the LED display section 82 such that the first display section 82a is lit.

When the user presses the button 81 and the operation signal is thus input (Yes in Step 801), the MPU 19 stops outputting the displacement correspondence amounts (Step 802) and switches the first mode to the second mode (Step 803). In this case, the MPU 19 does not immediately start outputting the scroll correspondence amounts.

Upon switching the mode, the MPU 19 controls the LED display section 82 such that the light of the first display section 82a is turned off and the second display section 82b is lit (Step 804).

Then, the MPU 19 judges whether the input of the operation signal has been canceled within the cycle time period since the input of the operation signal (Step 805). When the input of the operation signal has not been canceled within the cycle time period (No in Step 805), that is, when the user press-and-holds the button 81 for a time period equal to or longer than the cycle time period, the MPU 19 switches the second mode to the third mode (Step 803). Then, the MPU 19 controls the LED display section 82 such that the light of the second display section 82b is turned off and the third display section 82c is lit (Step 804).

The MPU 19 again judges whether the input of the operation signal has been canceled within the cycle time period since the end of the last cycle time period (Step 805), and when the input of the operation signal has not been canceled (No in Step 805), switches the third mode to the first mode (Step 803). Then, the MPU 19 controls the LED display section 82 such that the light of the third display section 82c is turned off and the first display section 82a is lit (Step 804).

When the user thus press-and-holds the button 81, the MPU 19 switches the modes successively in the stated order of the first mode, the second mode, and the third mode for each cycle time period.

Meanwhile, when the pressing of the button 81 is released within the cycle time period and the input of the operation signal is thus canceled (Yes in Step 805), the MPU 19 starts outputting the displacement correspondence amounts, the scroll correspondence amounts, or the zoom correspondence amounts in accordance with the mode at the time the input of the operation signal is canceled (Step 806).

Accordingly, the user can switch modes among the first to third modes with a simple pressing operation using the button 81.

In Step 803, the MPU 19 may switch the modes in the stated order of the first mode, the third mode, and the second mode. The mode of the input apparatus 1 when not input with an operation signal may be the second mode or the third mode.

Next, descriptions will be given on the input apparatus 1 according to another embodiment.

In the above embodiments, descriptions have been given on the case where any of the first to third modes is switched to the other one of the first to third modes. In embodiments described below, descriptions will be given on a case where, among the first to third modes, one of the two modes is switched to the other one of the two modes and vise versa. In this embodiment, points different from the embodiment shown in FIG. 10 will mainly be described.

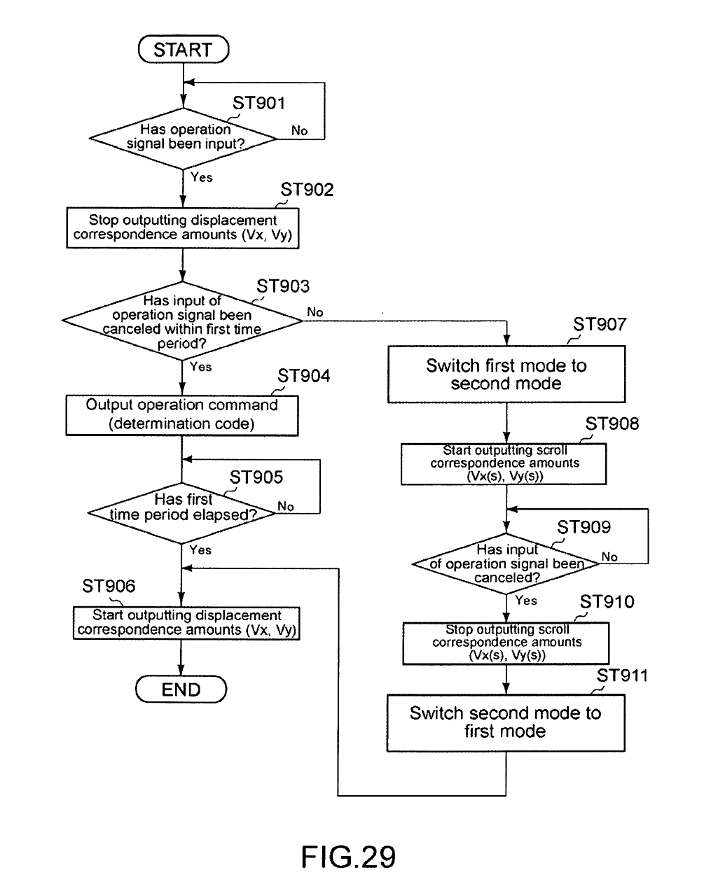

FIG. 29 is a flowchart showing an operation of the input apparatus 1 according to this embodiment.

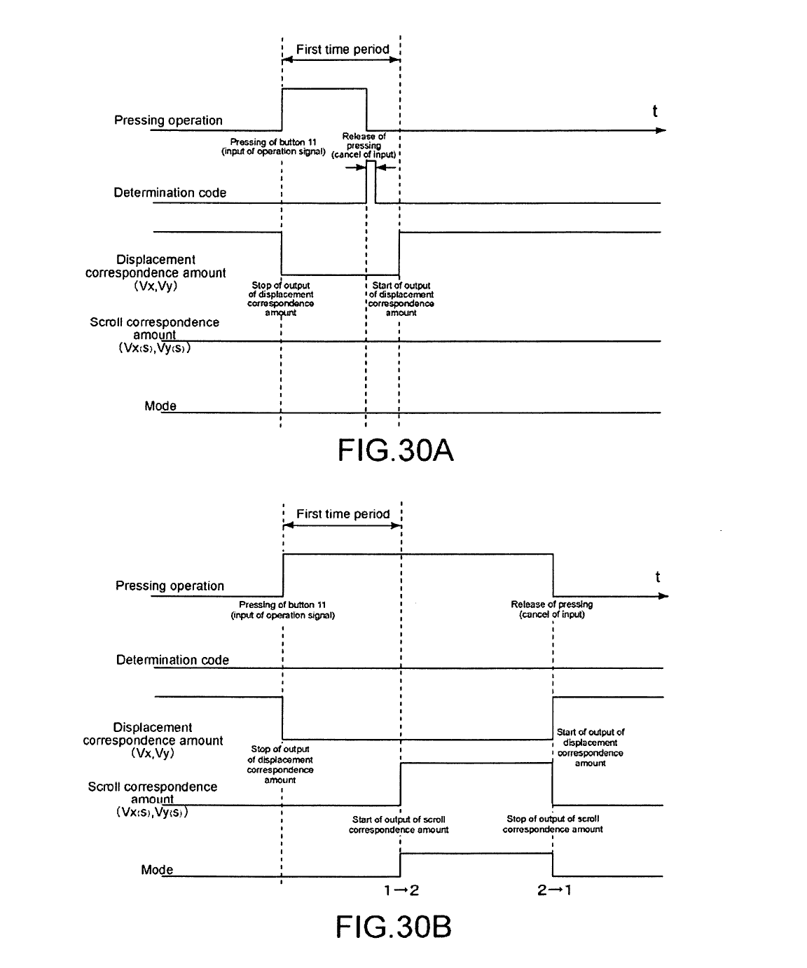

FIG. 30 are timing charts for illustrating the operation shown in FIG. 29. FIG. 30A shows a case where the user presses the button 11 and releases the pressing within the first time period, and FIG. 30B shows a case where the user press-and-holds the button 11 for a time period equal to or longer than the first time period.

When the button 11 is not pressed, the input apparatus 1 is outputting the displacement correspondence amounts (Vₓ, V_{y}) (No in Step 901). When the user presses the button 11 and the operation signal is thus input (Yes in Step 901), the MPU 19 stops outputting the displacement correspondence amounts (Step 902). When the input of the operation signal is canceled within the first time period since the start of the input of the operation signal (Yes in Step 903), the MPU 19 outputs a determination code (Step 904) and judges whether the first time period has passed since the start of the input of the operation signal (Step 905). When the first time period has passed (Yes in Step 905), the MPU 19 starts outputting the displacement correspondence amounts (Step 906) (see FIG. 30A). In other words, the button 11 exhibits the function as a determination button by being clicked by the user.

Meanwhile, when the input of the operation signal is not canceled within the first time period since the start of the input of the operation signal (No in Step 903), the MPU 19 switches the first mode to the second mode (Step 907) (mode switch means) and starts outputting the scroll correspondence amounts (Step 908).

When the pressing of the button 11 is released and the input of the operation signal from the switch is thus canceled (Yes in Step 909), the MPU 19 stops outputting the scroll correspondence amounts (Step 910). Then, the MPU 19 switches the second mode to the first mode (Step 911) and starts outputting the displacement correspondence amounts (Step 906) (see FIG. 30B). In other words, the button 11 exhibits the function as a mode switch button for switching the first mode to the second mode and vise versa, by being pressed by the user for a time period equal to or longer than the first time period.

By the processing shown in FIG. 29, the user can, for example, carry out an operation of inputting selection and execution of an icon (determination operation) by releasing the pressing of the button 11 within the first period since the start of the pressing, and carry out a scroll operation by operating the input apparatus 1 3-dimensionally after the button 11 is pressed and held for a time period equal to or longer than the first time period.

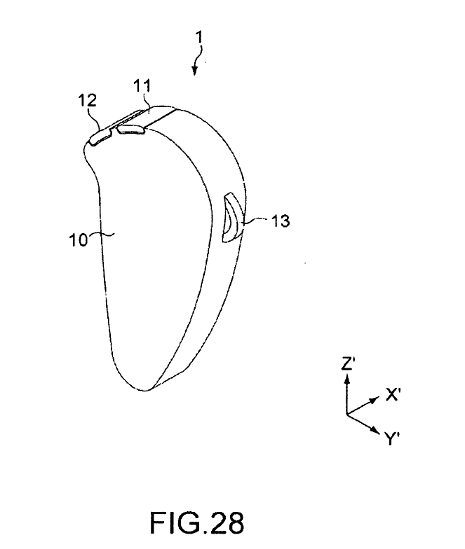

The input apparatus 1 may be provided with, on the side surface of the casing 10, a wheel button 13 as shown in FIG. 28. In this case, a zoom function is allocated to the wheel button 13. When the user rotates the wheel button 13 with a thumb, the letters 7 within the image 6 are zoomed in/out in accordance with a rotation amount of the wheel button 13 with respect to the casing 10.

The first mode may be switched to the third mode in Step 907, and the third mode may be switched to the first mode in Step 911. In this case, the wheel button 13 allocated with a scroll function may be provided to the input apparatus 1.

The processing shown in FIG. 29 may be executed by the control apparatus 40. In this case, the MPU 35 of the control apparatus 40 receives information on the displacement correspondence amounts output from the input apparatus 1, and receives a pressing signal as operational information of the button 11, for example. When the pressing signal is not input, the MPU 35 of the control apparatus 40 causes the pointer 2 to move on the screen 3 in accordance with the received displacement correspondence amounts. Upon start of reception of the input of the pressing signal, the MPU 35 causes the pointer 2 to stop, and when the input of the pressing signal is canceled within the first time period, executes predetermined processing in accordance with the position of the pointer 2. Meanwhile, when the pressing signal keeps being input for a time period equal to or longer than the first time period, the MPU 35 switches the first mode for controlling the display so as to move the pointer 2 on the screen 3 to the second mode for controlling the display so as to scroll the image 6. Then, the MPU 35 controls display so that the image 6 is scrolled at a scroll velocity value corresponding to the displacement correspondence amounts until the input of the pressing signal is canceled. It should be noted that the displacement correspondence amounts (velocity values) may be calculated by the control apparatus 40.

Next, descriptions will be given on the input apparatus 1 according to another embodiment. In this embodiment, points different from the embodiment shown in FIG. 29 will mainly be described.

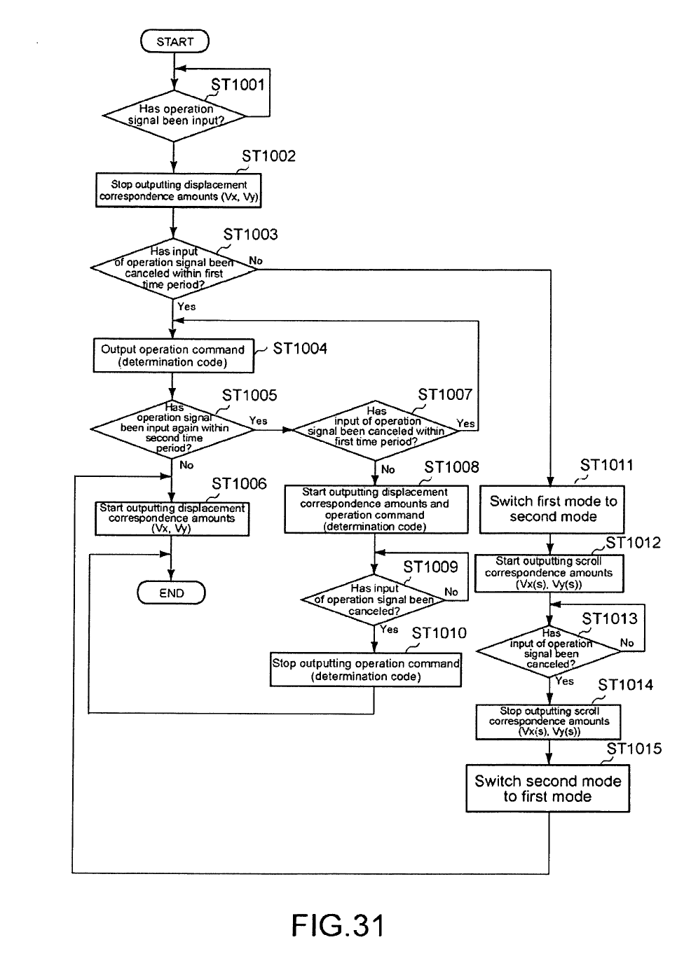

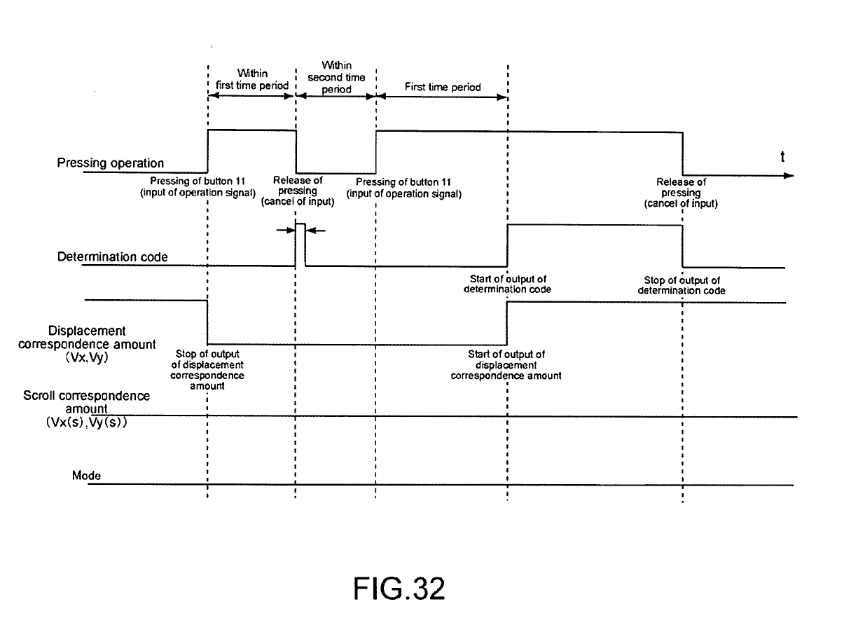

FIG. 31 is a flowchart showing an operation of the input apparatus 1 according to this embodiment. FIG. 32 is a timing chart for illustrating the operation shown in FIG. 31. FIG. 32 shows a case where, after releasing the pressing of the button 11 within the first time period, the user re-presses the button 11 within the second time period and keeps pressing the button 11 for a time period equal to or longer than the first time period.

Processing of Steps 1001 to 1006 and 1011 to 1015 in FIG. 31 is the same as that of Steps 901 to 906 and 907 to 911 of FIG. 29. Therefore, the button 11 exhibits the function corresponding to a determination button when being pressed by the user and released within the first time period, and exhibits the function corresponding to a mode switch button for switching the first mode to the second mode and vise versa by being pressed by the user for a time period equal to or longer than the first time period.

When the input of the operation signal is canceled within the first time period since the start of the input of the operation signal (Yes in Step 1003) and the operation signal is input again within the second time period since the cancel of the input of the operation signal (Yes in Step 1005), the MPU 19 judges whether the input of the operation signal is canceled within the first time period since the start of the input of the operation signal (Step 1007). When the input of the operation signal is not canceled within the first time period (No in Step 1007), the MPU 19 starts outputting the displacement correspondence amounts and a determination code as an operation command (Step 1008).

In other words, when the user re-presses, after releasing the pressing of the button 11 within the first time period, the button 11 within the second time period and keeps pressing the button 11 for a time period equal to or longer than the first time period (special pressing operation), the MPU 19 starts outputting the displacement correspondence amounts and the determination code after an elapse of the first time period since the re-pressing of the button 11 (Step 1008) (see FIG. 32). When the user carries out the special pressing operation on the button 11, the MPU 19 does not switch modes.

In this case, the control apparatus 40 receives the displacement correspondence amounts and the determination code output from the input apparatus 1 in parallel. When input with the displacement correspondence amounts and the determination code in parallel (see FIG. 32), the MPU 35 of the control apparatus 40 generates coordinate values (X(t), Y(t)) in accordance with the received displacement correspondence amounts (Vₓ, V_{y}). Then, when the pointer 2 is placed on the icon 4, the MPU 35 controls display such that the pointer 2 and the icon 4 move on the screen 3 in accordance with the coordinate values (X(t), Y(t)). In other words, the MPU 35 of the control apparatus 40 controls display of a drag operation when the displacement correspondence amounts and the determination code are input in parallel.

Upon start of the output of the displacement correspondence amounts and the determination code, the MPU 19 judges whether the input of the operation signal has been canceled (Step 1009), and when canceled (Yes in Step 1009), stops outputting the determination code (Step 1010).

When the output of the determination code is stopped in Step 1010, the MPU 35 of the control apparatus 40 ends the control of display of the drag operation on the screen 3 and controls display such that the pointer 2 moves on the screen 3.

By the processing shown in FIG. 31, when the user carries out the special pressing operation on the button 11, display of the drag operation is made on the screen 3. Accordingly, the user can carry out, for example, the operation of inputting selection and execution of an icon by releasing the pressed button 11 within the first time period, the scroll operation by operating the input apparatus 1 3-dimensionally after the button 11 is pressed and held for a time period equal to or longer than the first time period, and the drag operation by operating the input apparatus 1 3-dimensionally after the special pressing operation is made on the button 11.

In the processing of Steps 1011 and 1015, the MPU 19 may execute switch processing of switching the first mode to the third mode and vise versa.

Next, descriptions will be given on the input apparatus 1 according to another embodiment. In this embodiment, points different from the embodiment shown in FIG. 29 will mainly be described.

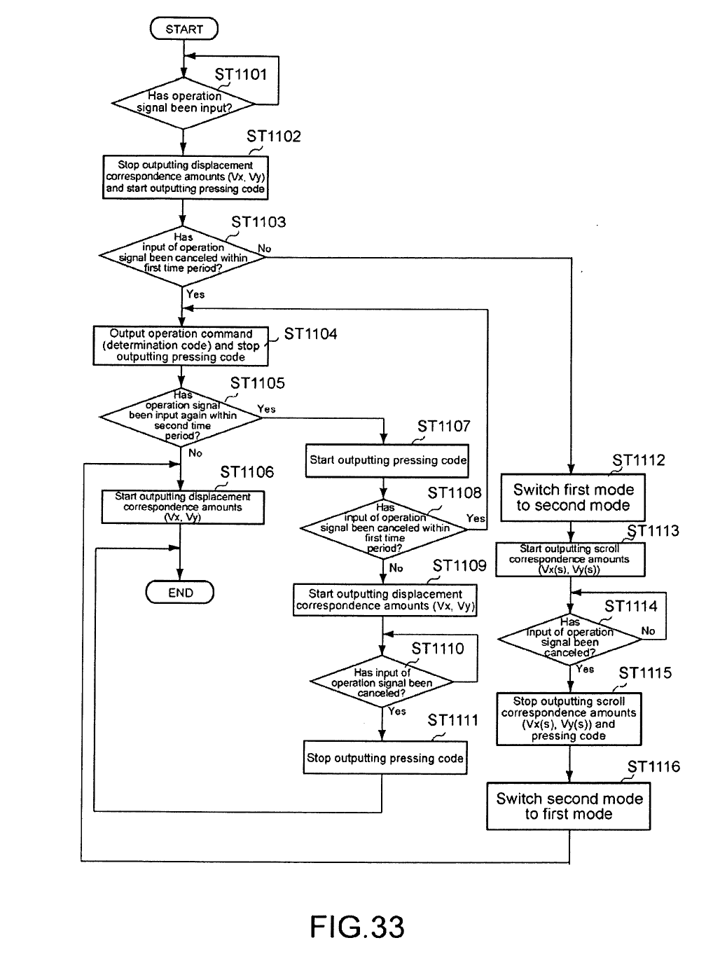

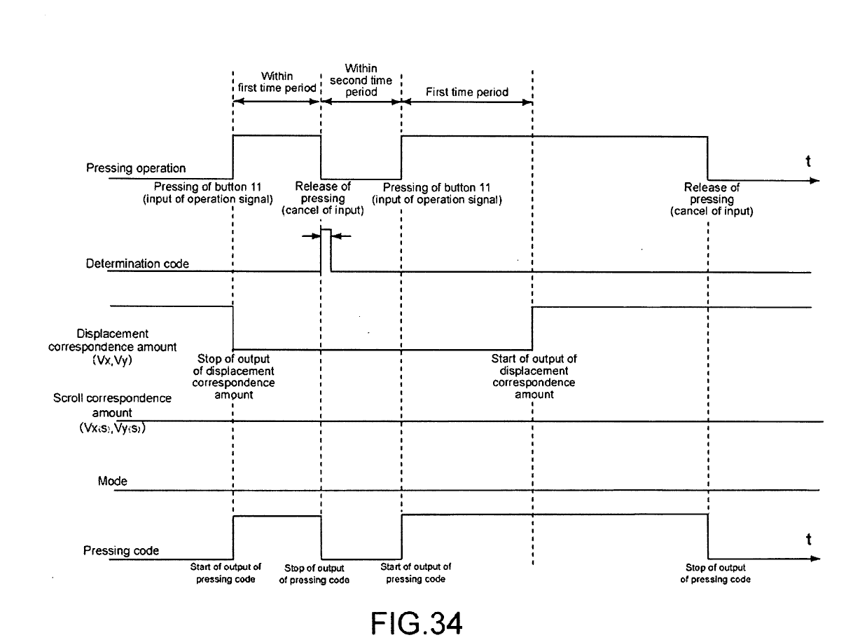

FIG. 33 is a flowchart showing an operation of the input apparatus 1 according to this embodiment. FIG. 34 is a timing chart for illustrating the operation shown in FIG. 33. It should be noted that FIG. 33 shows a case where the user carries out the special pressing operation on the button 11.

Processing of Steps 1011 to 1106 and 1112 to 1116 in FIG. 33 is the same as that of Steps 901 to 906 and 907 to 911 in FIG. 29. Therefore, the button 11 exhibits the function corresponding to a determination button when being pressed by the user and released within the first time period, and the function corresponding to a mode switch button for switching the first mode to the second mode and vise versa by being pressed by the user for a time period equal to or longer than the first time period.

In Steps 1102 and 1107 in the processing shown in FIG. 33, the MPU 19 starts outputting a pressing code in accordance with the start of the pressing of the button 11 to thus input the operation signal. Moreover, in Steps 1104, 1111, and 1115, the MPU 19 stops outputting the pressing code in accordance with the release of the pressing of the button 11 to thus cancel the input of the operation signal. In other words, the MPU 19 outputs the pressing code upon start of the pressing of the button 11 by the user until the user releases the pressing (see FIG. 34).

When the input of the operation signal is canceled within the first time period since the start of the input of the operation signal (Yes in Step 1103) and the operation signal is input again within the second time period since the cancel of the input of the operation signal (Yes in Step 1105), the MPU 19 starts outputting the pressing code (Step 1107). Then, the MPU 19 judges whether the input of the operation signal has been canceled within the first time period since the start of the input of the operation signal (Step 1108), and when the input of the operation signal is not canceled within the first time period (No in Step 1108), starts outputting the displacement correspondence amounts (Step 11109).

In other words, when the user carries out the special pressing operation on the button 11, the MPU 19 starts outputting the displacement correspondence amounts after an elapse of the first time period since the re-pressing of the button 11 (Step 1109) (see FIG. 34). When the user carries out the special pressing operation on the button 11, the MPU 19 does not switch modes.

In this case, the control apparatus 40 receives the displacement correspondence amounts and the pressing code output from the input apparatus 1 in parallel. When input with the displacement correspondence amounts and the pressing code in parallel (see FIG. 34), the MPU 35 of the control apparatus 40 generates coordinate values (X(t), Y(t)) in accordance with the received displacement correspondence amounts (Vₓ, V_{y}). Then, when the pointer 2 is placed on the icon 4, the MPU 35 controls display such that the pointer 2 and the icon 4 move on the screen 3 in accordance with the coordinate values (X(t), Y(t)). In other words, the MPU 35 of the control apparatus 40 controls display of the drag operation when the displacement correspondence amounts and the pressing code are input in parallel.

Upon start of the output of the displacement correspondence amounts, the MPU 19 judges whether the input of the operation signal has been canceled (Step 1110), and when canceled (Yes in Step 1110), stops outputting the pressing code (Step 1111).

When the output of the pressing code is stopped in Step 1111, the MPU 35 of the control apparatus 40 ends the control of display of the drag operation on the screen 3 and controls display such that the pointer 2 moves on the screen 3.

By the processing shown in FIG. 33, when the user carries out the special pressing operation on the button 11, display of the drag operation is made on the screen 3. Accordingly, the user can carry out, for example, the operation of inputting selection and execution of an icon by releasing the pressed button 11 within the first time period, the scroll operation by operating the input apparatus 1 3-dimensionally after the button 11 is pressed and held for a time period equal to or longer than the first time period, and the drag operation by operating the input apparatus 1 3-dimensionally after the special pressing operation is made on the button 11.

In the processing of Steps 1112 and 1116, the MPU 19 may execute switch processing of switching the first mode to the third mode and vise versa.

Next, descriptions will be given on the input apparatus 1 according to another embodiment. In this embodiment, points different from the embodiment shown in FIG. 20 will mainly be described.

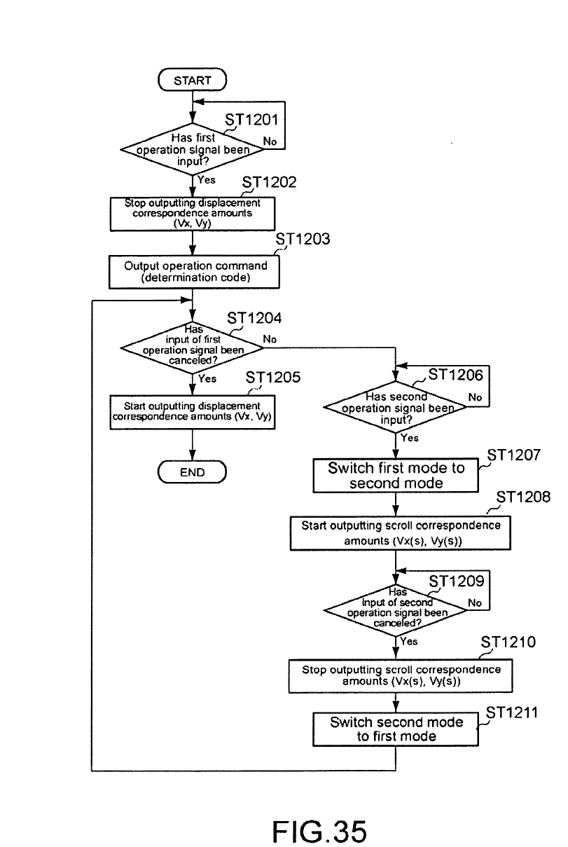

FIG. 35 is a flowchart showing an operation of the input apparatus 1 according to this embodiment. As in the embodiment shown in FIG. 20, the input apparatus 1 according to this embodiment is provided with, on the casing 10, the operation section 50 including the 2-step action shown in FIG. 19. In this embodiment, the operation section 50 is typically disposed at a position of the button 11 shown in FIG. 6, though not limited thereto. The operation section 50 may alternatively be disposed at a position of the button 12 or at a position on the side surface of the casing 10 where the user is capable of operating with a thumb.

As shown in FIG. 35, when the first button 57 is not pressed and the first operation signal is thus not input to the MPU 19, the input apparatus 1 is in the first mode and the MPU 19 is outputting the displacement correspondence amounts (Vₓ, V_{y}) (No in Step 1201). In this case, by the user swinging the input apparatus 1 in the yaw or pitch direction, for example, the pointer 2 moves on the screen 3.

When the user presses the surface button 56 halfway (see FIG. 19B), the first button 57 is pressed and the first operation signal from the first switch is thus input (Yes in Step 1201). The MPU 19 then stops outputting the displacement correspondence amounts (Step 1202). Alternatively, the MPU 19 starts outputting the displacement correspondence amounts (Vₓ, V_{y}) set to 0. Accordingly, it becomes possible to prevent processing unintended by the user from being executed on the screen 3 due to the tilt of the casing 10 after the start of the pressing of the 2-step operation section 50.

Upon stop of the output of the displacement correspondence amounts, the MPU 19 outputs the determination code (Step 1203). When the pointer 2 is placed on, for example, the icon 4 on the screen 3 when the determination code is output from the input apparatus 1, processing corresponding to the icon 4 is executed on the screen 3. In other words, the first button 57 exhibits the function corresponding to a determination button.

Upon output of the determination code, the MPU 19 judges whether the input of the first operation signal has been canceled (Step 1204), and when canceled (Yes in Step 1204), starts outputting the displacement correspondence amounts (Vₓ, V_{y}) (Step 1205).

Meanwhile, when, without the input of the first operation signal being canceled (No in Step 1204), the operation signal from the second switch is input to the MPU 19 (Yes in Step 1206), the MPU 19 switches the first mode to the second mode (Step 1207). In other words, when the user presses the surface button 56 by the second distance (see FIG. 19C), the MPU 19 switches the first mode to the second mode. Thus, the second button 58 exhibits the function corresponding to a mode switch button for switching the first mode to the second mode and vise versa.

Upon switching the mode to the second mode, the MPU 19 starts outputting the scroll correspondence amounts (Vₓ₍ₛ₎, V_{y(s)}). Upon receiving the scroll correspondence amounts, the MPU 35 of the control apparatus 40 controls, when the image 6 on the screen 3 is active, for example, display such that the letter 7 within the image 6 are scrolled at a velocity corresponding to the scroll correspondence amounts. Therefore, when the user swings the input apparatus 1 while still pressing the surface button 56 by the second distance, the letters 7 within the image 6 are scrolled.

Upon start of the output of the scroll correspondence amounts, the MPU 19 of the input apparatus 1 judges whether the input of the second operation signal from the second switch has been canceled (Step 1209). When the user lifts the surface button 56 halfway (see FIG. 19B) and the pressing of the second button 58 is thus released, the input of the second operation signal is canceled (Yes in Step 1209). The MPU 19 then stops outputting the scroll correspondence amounts (Step 1210) and switches the second mode to the first mode (Step 1211). After that, the MPU 19 again judges whether the input of the first operation signal has been canceled (Step 1204).

By the processing shown in FIG. 35, the user can successively make a switch between the first button corresponding to the determination button and the second button corresponding to the mode switch button for switching the first mode to the second mode and vise versa. Accordingly, intuitional operations become possible.

The input apparatus 1 may be provide with, on the side surface of the casing 10, the wheel button 13 as shown in FIG. 28. In this case, the wheel button 13 is allocated with a zoom function. When the user rotates the wheel button 13 with a thumb, the letters 7 within the image 6 on the screen 3 are zoomed in/out in accordance with the rotation amount of the wheel button 13 with respect to the casing 10.

The MPU 19 may switch the first mode to the third mode in Step 1207 and switch the third mode to the first mode in Step 1211. In this case, by the user swinging the input apparatus 1 while still pressing the surface button 56 by the second distance (see FIG. 19C), the letters 7 within the image 6 are zoomed in/out.

Next, descriptions will be given on processing of the input apparatus 1 according to another embodiment.

In this embodiment, points different from the embodiment shown in FIG. 35 will mainly be described. The input apparatus 1 is provide with, on the casing thereof, the operation section 50 including the 2-step action similar to that shown in FIG. 19.

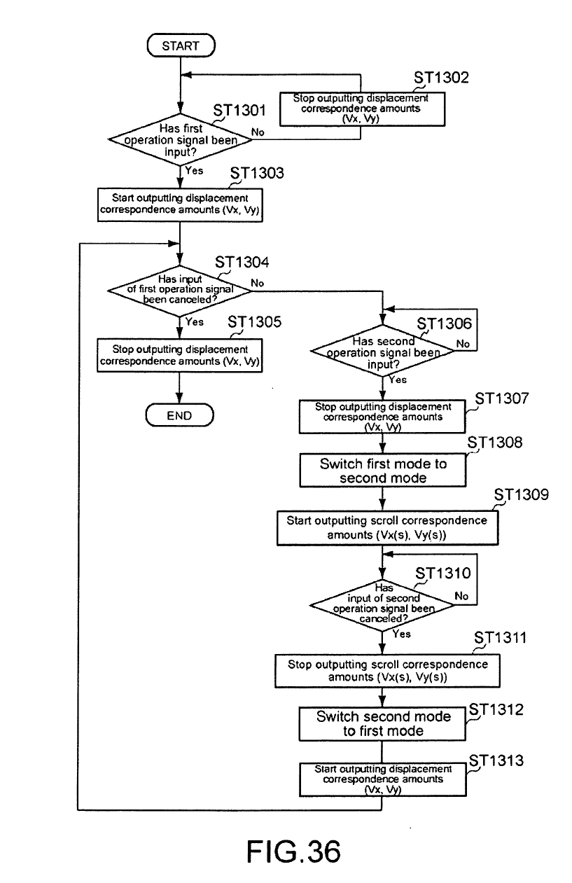

FIG. 36 is a flowchart showing an operation of the input apparatus 1 according to this embodiment.

The operation section 50 of the input apparatus 1 according to this embodiment is not allocated with the function corresponding to a determination button. Therefore, as in FIG. 19, the operation section 50 is disposed at a position on the side surface of the casing 10 where the user is capable of operating with a thumb (see FIG. 6), though not limited thereto. The operation section 50 may be disposed at the position of the buttons 11 and 12 shown in FIG. 6.

As shown in FIG. 36, when the first operation signal is not input to the MPU 19 (No in Step 1301), the input apparatus 1 is in the first mode, but the displacement correspondence amounts are not output (Step 1302). Therefore, even when the user swings the input apparatus 1, the pointer 2 does not move on the screen 3.

When the user presses the surface button 56 halfway and the first operation signal from the first switch is thus input (Yes in Step 1301), the MPU 19 starts outputting the displacement correspondence amounts (Step 1303). By the user swinging the input apparatus 1 while still pressing the surface button 56 halfway, the pointer 2 moves on the screen 3.

Upon start of the output of the displacement correspondence amounts, the MPU 19 judges whether the input of the first operation signal has been canceled (Step 1304). For example, when the user releases the finger 34 from the surface button 56 and the input of the first operation signal is thus canceled (Yes in Step 1304), the MPU 19 stops outputting the displacement correspondence amounts (Step 1305).

By the processing of Steps 1301 to 1305, the user can start moving the pointer by pressing the surface button 56 halfway, and stop moving the pointer by releasing the finger 34 from the surface button 56. In other words, in this embodiment, the first button 57 exhibits the function corresponding to a movement control button for controlling start/stop of a movement of the pointer.

Meanwhile, when the input of the first operation signal is not canceled (No in Step 1304) and the second operation signal is input while the first operation signal is still being input (Yes in Step 1306), the MPU 19 stops outputting the displacement correspondence amounts (Step 1307). After that, the MPU 19 switches the first mode to the second mode (Step 1308) and starts outputting the scroll correspondence amounts (Step 1309). In other words, in this embodiment, the second button 58 exhibits the function corresponding to the mode switch button for switching the first mode to the second mode and vise versa.

When the user swings the input apparatus 1 while still pressing the surface button 56 by the second distance, the letters 7 within the image 6 displayed on the screen 3 are scrolled.

The MPU 19 then judges whether the input of the second operation signal has been canceled (Step 1310), and when canceled (Yes in Step 1310), stops outputting the scroll correspondence amounts (Step 1311) and switches the second mode to the first mode (Step 1312). Then, the MPU 19 starts outputting the displacement correspondence amounts (Step 1313) and again judges whether the input of the first operation signal has been canceled (Step 1304).

By the operation shown in FIG. 36, it is possible to successively make a switch between the first button 57 having the function corresponding to a movement control button and the second button 58 having the function corresponding to a mode switch button for switching the first mode to the second mode and vise versa. Accordingly, intuitional operations become possible.

The MPU 19 may execute processing such that the first button 57 exhibits the function corresponding to a mode switch button capable of switching modes and the second button 58 exhibits the function corresponding to a movement control button.

Next, descriptions will be given on a method of calculating the scroll correspondence amounts output by the input apparatus 1 according to the embodiments.

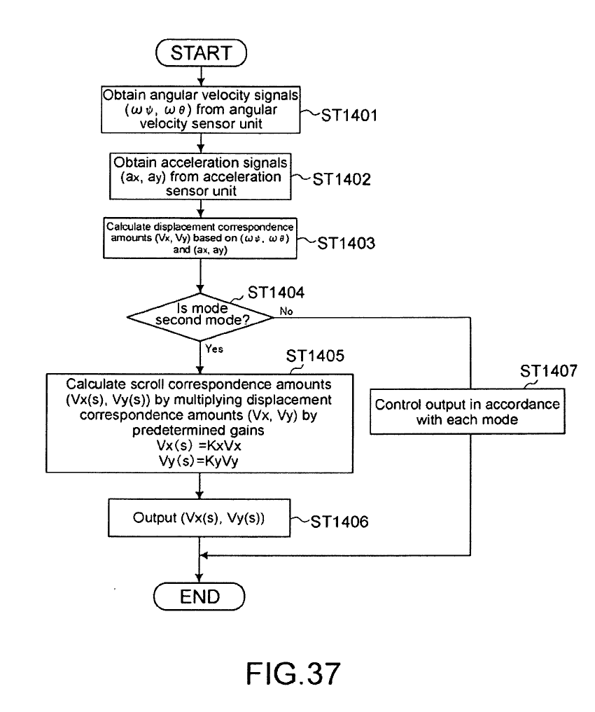

FIG. 37 is a flowchart showing an operation of the input apparatus 1 according to an embodiment regarding the method of calculating the scroll correspondence amounts.

As shown in FIG. 37, upon input of the physical amount signals (ω_{ψ}, ω_{θ}, aₓ, a_{y}) from the angular velocity sensor unit 15 and the acceleration sensor unit 16, the MPU 19 calculates the displacement correspondence amounts (Vₓ, V_{y}) based on the physical amounts (Steps 1401 to 1403). Then, the MPU 19 judges whether the mode is the second mode (Step 1404), and when the mode is not the second mode (No in Step 1404), controls the output according to the corresponding mode (Step 1407).

On the other hand, when the mode is the second mode (Yes in Step 1404), the MPU 19 calculates the scroll correspondence amounts (Vₓ₍ₛ₎, V_{y(s)}) by respectively multiplying the calculated displacement correspondence amounts by predetermined gain values (Kₓ, K_{y}) as respectively expressed in Equations (3) and (4) below (Step 1405).

Vₓ₍ₛ₎=Kₓ*Vₓ (3)

V_{y(s)}=K_{y}*V_{y} (4)

The MPU 19 transmits the scroll correspondence amounts to the control apparatus 40 via the transceiver 21 and the antenna 22 (Step 1406). Upon receiving the scroll correspondence amounts via the antenna 39 and the transceiver 38, the MPU 35 of the control apparatus 40 controls display so that the letters 7 within the image 6 displayed on the screen 3 are scrolled in accordance with the scroll correspondence amounts, for example.

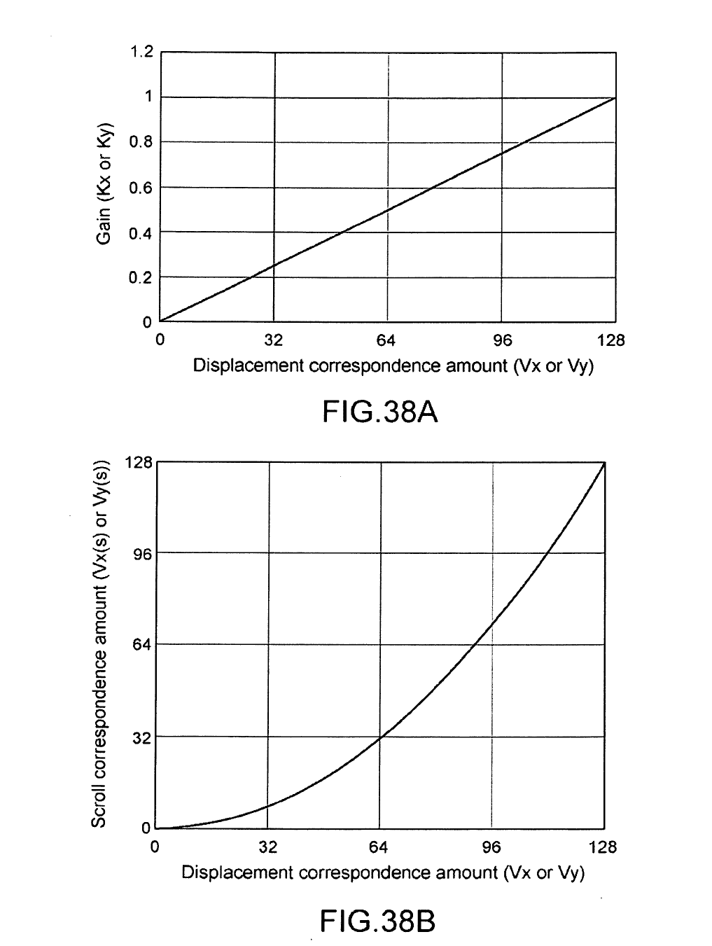

FIG. 38A is a graph showing an example of a profile of at least one of the gain values (Kₓ, K_{y}) respectively shown in Equations (3) and (4). In FIG. 38A, the abscissa axis represents at least one of the displacement correspondence amounts (Vₓ, V_{y}) calculated in Step 1403, and the ordinate axis represents at least one of the gain values (Kₓ, K_{y}). In other words, at least one of the gain values (Kₓ, K_{y}) is a function of at least the corresponding one of the displacement correspondence amounts (Vₓ, V_{y}). FIG. 38A shows a profile in which the gain value increases by a linear function in proportion with the displacement correspondence amount.

In descriptions below, the gain profile as shown in FIG. 38A will be described assuming that the abscissa axis represents one of the displacement correspondence amounts (Vₓ, V_{y}) and the ordinate axis represents one of the gain values (Kₓ, K_{y}) corresponding to the one of the displacement correspondence amounts (Vₓ, V_{y}) concerned.

FIG. 38B is a graph showing a profile of the scroll correspondence amount (hereinafter, referred to as scroll profile) obtained by the gain profile shown in FIG. 38A. As in FIG. 38A, the abscissa axis represents at least one of the displacement correspondence amounts (Vₓ, V_{y}) obtained in Step 1403. The graph of the scroll profile shown in FIG. 38B is obtained by temporally differentiating the gain profile shown in FIG. 38A. The gain is a value obtained with one of the displacement correspondence amounts (Vₓ, V_{y}) as an input and one of the scroll correspondence amounts (V_{x(s), V}_{y(s)}) as an output.

The MPU 19 only needs to store the function representing the gain profile in the memory and dynamically calculate the scroll correspondence amounts using the stored function. Alternatively, a lookup table generated based on the gain profile may be stored in the memory in advance, the lookup table showing the correspondences between the displacement correspondence amounts (Vₓ, V_{y}) and the scroll correspondence amounts.

By calculating the scroll correspondence amounts in Step 1405 in the processing as described above, when the user moves the input apparatus 1 at a relatively low velocity, the letters 7 within the image 6 are scrolled at a low velocity. Accordingly, the user becomes capable of performing accurate scroll operations. Meanwhile, when the user moves the input apparatus at a high velocity, since large gains are multiplied to the displacement correspondence amounts, the letters 7 within the image 6 are scrolled at an extremely high velocity. Accordingly, operations of files that are long in the Y- or X-axis direction on the screen 3, for example, are facilitated.

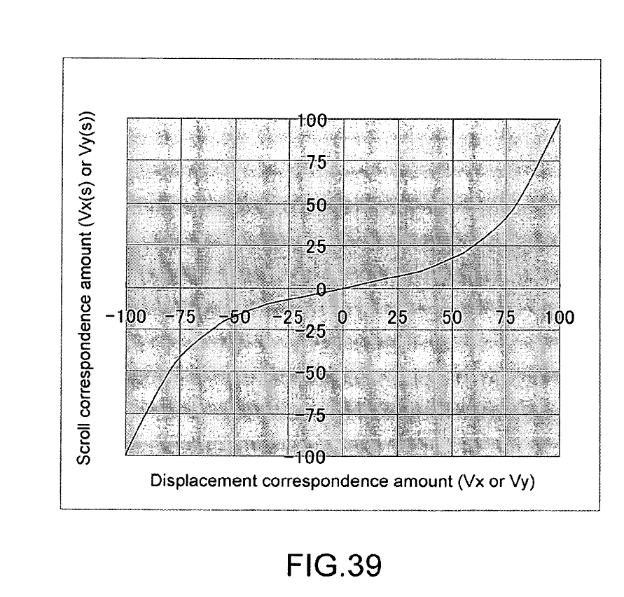

In the typical example of FIG. 38A, the gain value increases by a linear function in proportion with the displacement correspondence amount. However, the present application is not limited thereto, and the gain value may increase by a multi-degree function of a quadratic function or more, stepwise, by a combination of at least two of the above, or by various other ways. It should be noted that FIG. 39 shows another example of the scroll profile as a reference.

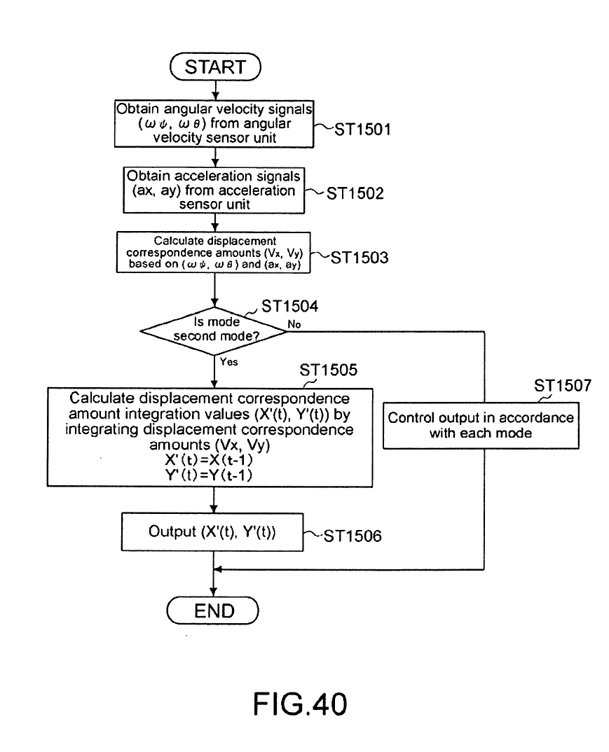

In Steps 1404 (YES in Step 1404) to 1405, the MPU 19 may compare (absolute values of) the first and second displacement correspondence amounts (Vₓ, V_{y}) and calculate the scroll correspondence amounts based on one of the displacement correspondence amounts having a larger value. Alternatively, in Step 1406, the MPU 19 may compare the first and second scroll correspondence amounts (Vₓ₍ₛ₎, V_{y(s)}) and output one of the scroll correspondence amounts having a larger value. In this case, the MPU 19 performs control so as to stop the output of the smaller one of the first and second scroll correspondence amounts (output control means). The same processing may be carried out in an operation shown in FIG. 40, which will be described later.

Accordingly, it becomes possible to bias the direction of the scroll operation in the horizontal direction or the vertical direction on the screen 3, for example. Thus, operations of files that are long in the vertical or horizontal direction are facilitated additionally.

Next, the method of calculating the scroll correspondence amounts according to another embodiment of the present application will be described. FIG. 40 is a flowchart showing an operation of the input apparatus 1 according to this embodiment.

As shown in FIG. 40, upon input of the physical amount signals (ω_{ψ}, ω_{θ}, aₓ, a_{y}) from the angular velocity sensor unit 15 and the acceleration sensor unit 16, the MPU 19 calculates the displacement correspondence amounts (Vₓ, V_{y}) based on the physical amounts (Steps 1501 to 1503). Then, the MPU 19 judges whether the mode is the second mode (Step 1504), and when the mode is not the second mode (No in Step 1504), controls the output according to the corresponding mode (Step 1507).

On the other hand, when the mode is the second mode (Yes in Step 1504), the MPU 19 calculates displacement correspondence amount integration values (X′(t), Y′(t)) as respectively expressed in Equations (5) and (6) below (Step 1505). In this case, the integration operation of the displacement correspondence amounts is started when the mode is switched to the second mode, for example, and the operational values of the displacement correspondence amounts are reset to zero when the second mode is switched to another mode.

X′(t)=X′(t−1)+Vₓ (5)

Y′(t)=Y′(t−1)+V_{y} (6)

The MPU 19 transmits, as the scroll correspondence amounts, the displacement correspondence amount integration values to the control apparatus 40 via the transceiver 21 and the antenna 22 (Step 1506). Upon receiving the displacement correspondence amount integration values via the antenna 39 and the transceiver 38, the MPU 35 of the control apparatus 40 controls display so that the letters 7 within the image 6 displayed on the screen 3 are scrolled at a velocity corresponding to the displacement correspondence amount integration values, for example.

According to the processing as described above, by the user swinging the input apparatus 1 in its reference position in the pitch direction by a rotation about the base of an arm and holding the input apparatus 1 in that state, the letters 7 within the image 6 are scrolled continuously in the Y-axis direction. Alternatively, by the user moving the input apparatus 1 in its reference position in the yaw direction and holding the input apparatus 1 in that state, the letters 7 within the image 6 are scrolled continuously in the X-axis direction. As described above, with the input apparatus 1 according to this embodiment, the user can perform steady scroll operations without having to move the input apparatus 1 much.

Next, a method of calculating the zoom correspondence amounts output by the input apparatus 1 according to the above embodiments will be described.

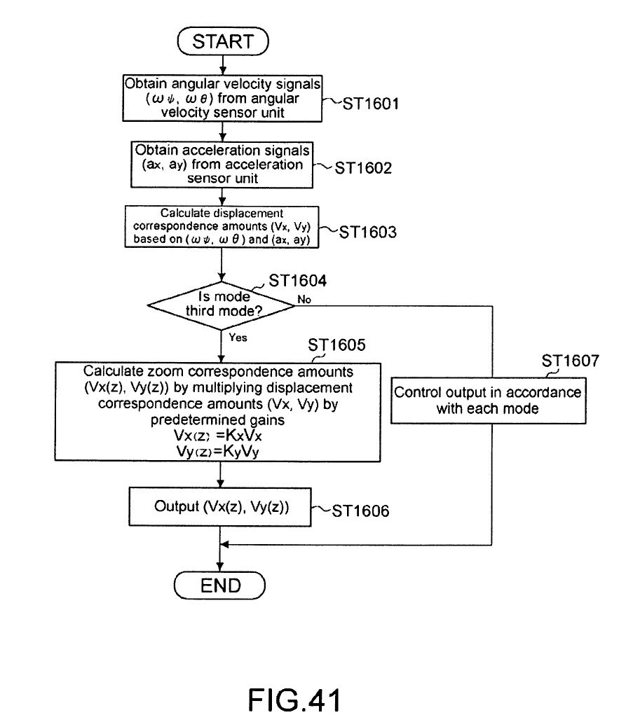

FIG. 41 is a flowchart showing an operation of the input apparatus 1 according to the embodiment regarding the method of calculating the zoom correspondence amounts.

The MPU 19 receives an input of the physical amount signals from the sensor unit 17 and calculates the displacement correspondence amounts corresponding to the physical amounts (Steps 1601 to 1603). The MPU 19 then judges whether the mode is the third mode (Step 1604), and when the mode is the third mode (Yes in Step 1604), calculates the zoom correspondence amounts (V_{x(z)}, V_{y(z)}) by multiplying the calculated displacement correspondence amounts by predetermined gains (Step 1605). The gains to be multiplied are values that increase by a linear function in proportion with the displacement correspondence amounts as shown in FIG. 38A, for example. However, the present application is not limited thereto, and the gains may increase by a multi-degree function of a quadratic function or more, stepwise, or by a combination of at least two of the above.

Upon calculating the zoom correspondence amounts (V_{x(z)}, V_{y(z)}), the MPU 19 outputs the zoom correspondence amounts (Step 1606). Upon receiving the zoom correspondence amounts, the MPU 35 of the control apparatus 40 controls display so that the letters 7 within the image 6 are zoomed in/out at a velocity corresponding to the zoom correspondence amounts.

Accordingly, accurate zoom operations become possible by the 3-dimensional operations of the input apparatus 1 in a low velocity range, and zoom operations at an extremely high velocity become possible by the 3-dimensional operations of the input apparatus 1 in a high velocity range.

The MPU 19 may calculate only one of the first and second zoom correspondence amounts (V_{x(z)}, V_{y(z)}) in Step 1605. Accordingly, power consumption can be reduced. For example, in a case where only the second zoom correspondence amount is calculated and output from the input apparatus 1, letters 7 within the image 6 are zoomed in/out when the user swings the input apparatus 1 in the pitch direction whereas the letters 7 within the image 6 are not zoomed in/out when the user swings the input apparatus 1 in the yaw direction. However, even when the letters 7 within the image 6 are not zoomed in/out when the input apparatus 1 is swung in the yaw direction, the operational feeling of the user is not impaired.

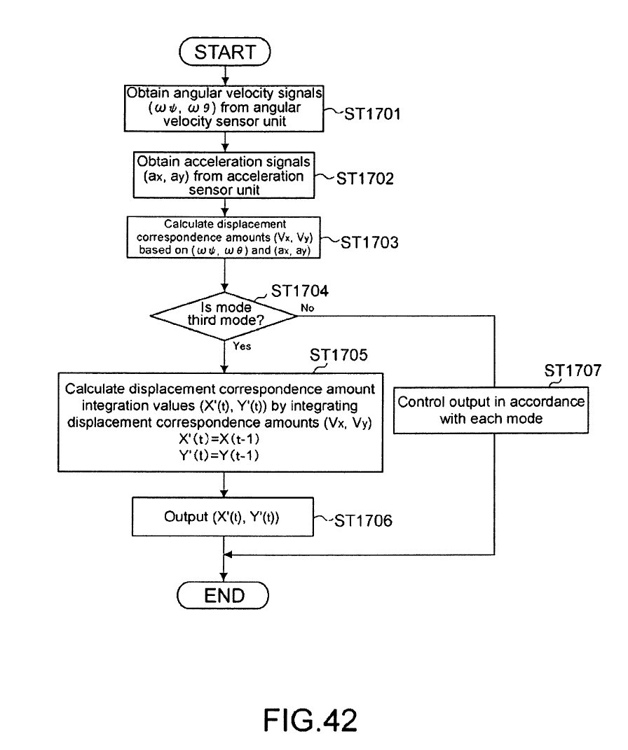

Next, the method of calculating the zoom correspondence amounts according to another embodiment will be described. FIG. 42 is a flowchart showing an operation of the input apparatus 1 according to this embodiment.

The MPU 19 receives an input of the physical amount signals from the sensor unit 17 and calculates the displacement correspondence amounts corresponding to the physical amounts (Steps 1701 to 1703). The MPU 19 then judges whether the mode is the third mode (Step 1704), and when the mode is the third mode (Yes in Step 1704), calculates the displacement correspondence amount integration values (X′(t), Y′(t)) by integrating the displacement correspondence amounts (Step 1705). The MPU 19 outputs the displacement correspondence amount integration values as the zoom correspondence amounts (Step 1706).

Upon receiving the displacement correspondence amount integration values via the antenna 39 and the transceiver 38, the MPU 35 of the control apparatus 40 controls display so that the letters 7 within the image 6 displayed on the screen 3 are zoomed in/out at a velocity corresponding to the displacement correspondence amount integration values, for example.

By the processing as described above, the user can perform steady zoom operations without having to move the input apparatus 1 much.

The MPU 19 may calculate only one of the first and second integration values (X′(t), Y′(t)) in Step 1705. Accordingly, power consumption can be reduced. It should be noted that the operational feeling of the user in the zoom operation is also not impaired by the processing as described above.

In the descriptions made with reference to FIGS. 37 to 42, the case where the processing of calculating the scroll correspondence amounts or zoom correspondence amounts is executed on the input apparatus 1 side has been described. However, the present application is not limited thereto, and the processing of calculating the scroll correspondence amounts or zoom correspondence amounts may be executed by the control apparatus 40. In this case, for example, the control apparatus 40 calculates the scroll correspondence amounts or the zoom correspondence amounts based on the displacement correspondence amounts output from the input apparatus 1.

The present application is not limited to the above embodiments, and various other embodiments may also be employed.

In the descriptions above, as the operation section 23, the press-type buttons 11, 57, 58, 61, 71, and 81 haven been taken as an example. However, the present application is not limited thereto, and a slide-type button, a rotary-type button, a stick-type button operated with one end as a fulcrum, and the like may be used instead.

In the descriptions made with reference to FIG. 19, the operation section including the first button 57, the second button 58, and the surface button 56 has been exemplified as the 2-step operation section. However, the 2-step operation section is not limited thereto and may have any structure as long as 2-step switching is possible.

In the above embodiments, the input apparatus 1 transmits the input information to the control apparatus 40 wirelessly. However, the input information may be transmitted by wires.

The present application may be applied to, for example, a handheld-type information processing apparatus (handheld apparatus) including a display section. In this case, the user moves a main body of the handheld apparatus to move a pointer displayed on the display section or cause an image displayed on the display section to be scrolled or zoomed in/out. Examples of the handheld apparatus include a PDA (Personal Digital Assistance), a cellular phone, a portable music player, and a digital camera.

In the above embodiments, the pointer 2 that moves on the screen in accordance with the movement of the input apparatus 1 is represented as an image. However, the image of the pointer 2 is not limited to the arrow, and the shape of the pointer 2 may be a simple circle, square, or the like, or the image thereof may be a character image or any other image.

In the above embodiments, the descriptions have been given on the biaxial acceleration sensor unit and the biaxial angular velocity sensor unit. However, the present application is not limited thereto, and the input apparatus 1 may include a triaxial acceleration sensor unit and a triaxial angular velocity sensor unit, the three axes being mutually orthogonal, or may include only one of the two sensor units. In either case, the processing described in the above embodiments can still be realized. Alternatively, the input apparatus 1 may include a uniaxial acceleration sensor or a uniaxial angular velocity sensor. Typically in this case, a plurality of UIs as pointing targets of the pointer 2 displayed on the screen 3 are arranged on the screen 3 uniaxially.

Alternatively, the input apparatus 1 may include a geomagnetic sensor, an image sensor, and the like instead of the acceleration sensors and the angular velocity sensors.

The detection axes of each of the angular velocity sensor unit 15 and the acceleration sensor unit 16 of the sensor unit 17 do not necessarily need to be mutually orthogonal like the X′ axis and the Y′ axis. In this case, the accelerations respectively projected in the mutually-orthogonal axial directions can be obtained by a calculation that uses a trigonometric function. Similarly, the angular velocities about the mutually-orthogonal axes can be obtained by the calculation that uses the trigonometric function.

Regarding the sensor unit 17 described in the above embodiments, the descriptions have been given on the case where the detection axes of the X′ axis and the Y′ axis of the angular velocity sensor unit 15 and the detection axes of the X′ axis and the Y′ axis of the acceleration sensor unit 16 respectively match each other. However, the detection axes do not necessarily need to match. For example, in a case where the angular velocity sensor unit 15 and the acceleration sensor unit 16 are mounted on a substrate, the angular velocity sensor unit 15 and the acceleration sensor unit 16 may be mounted while the detection axes thereof are deviated a predetermined rotation angle on a main surface of the substrate so that the detection axes do not match. In this case, the accelerations and angular velocities on the respective axes can be obtained by the calculation that uses the trigonometric function.

In the above embodiments, the case where the input apparatus 1 is operated 3-dimensionally has been described. However, the embodiments are not limited thereto, and the input apparatus may be operated while a part of the casing 10 is in contact with a table, for example.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An input apparatus controlling a movement of a pointer and an image displayed on a screen, the input apparatus comprising:
a casing;
a sensor to detect a physical amount corresponding to a movement of the casing;
an operation section through which an operation is input; and
a mode switch section to make a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section.

2. The input apparatus according to claim 1,
wherein the operation section is a single operation section,
the input apparatus further comprising:
a command output section to output a determination command in accordance with the operation to the operation section; and
a controller to control the command output section and the mode switch section so that one of the output of the determination command and the switch of any of the first mode, the second mode, and the third mode is executed in accordance with a timing of the operation to the operation section.

3. The input apparatus according to claim 2,
wherein the controller controls the command output section so that, when the operation to the operation section is canceled within a first time period since a start of the operation, the determination command is output, and
wherein the controller controls the mode switch section so that, when the operation to the operation section is not canceled within the first time period since the start of the operation, any of the first mode, the second mode, and the third mode is switched to any other one of the first mode, the second mode, and the third mode.

4. The input apparatus according to claim 3,
wherein the controller controls the mode switch section so that, when the operation to the operation section is canceled within the first time period since the start of the operation, and the operation is started again within a second time period since the cancel of the operation but the operation is not canceled within the first time period, any of the first mode, the second mode, and the third mode is switched to any other one of the first mode, the second mode, and the third mode.

5. The input apparatus according to claim 2,
wherein the controller controls the command output section so that, when the operation to the operation section is canceled within a first time period since a start of the operation, the determination command is output, and
wherein the controller controls the mode switch section so that, when the operation to the operation section is not canceled within the first time period since the start of the operation, any of the first mode, the second mode, and the third mode is switched to any other one of the first mode, the second mode, and the third mode every time a predetermined time passes from after an end of the first time period to the cancel of the operation.

6. The input apparatus according to claim 1, further comprising:
a calculation section to calculate a displacement correspondence amount corresponding to a displacement amount of the pointer that corresponds to the physical amount; and
an output section to output information on the displacement correspondence amount and mode switch information as information indicating the switch of any of the first mode, the second mode, and the third mode to any other one of the first mode, the second mode, and the third mode.

7. The input apparatus according to claim 1, further comprising:
a calculation section to calculate a displacement correspondence amount corresponding to a displacement amount of the pointer that corresponds to the physical amount, a scroll correspondence amount corresponding to a scroll amount of the image that corresponds to the physical amount, and a zoom correspondence amount corresponding to a zoom amount of the image that corresponds to the physical amount; and
an output section to output information on the displacement correspondence amount during the first mode, information on the scroll correspondence amount during the second mode, and information on the zoom correspondence amount during the third mode.

8. The input apparatus according to claim 7,
wherein the calculation section calculates one of the scroll correspondence amount and the zoom correspondence amount based on the displacement correspondence amount.

9. The input apparatus according to claim 8,
wherein the calculation section calculates one of the scroll correspondence amount and the zoom correspondence amount by multiplying the displacement correspondence amount by a gain that increases along with the displacement correspondence amount.

10. The input apparatus according to claim 8,
wherein the calculation section calculates one of the scroll correspondence amount and the zoom correspondence amount by integrating the displacement correspondence amount.

11. The input apparatus according to claim 8,
wherein the calculation section calculates a first scroll correspondence amount based on a first displacement correspondence amount corresponding to the displacement amount of the pointer in a first direction on the screen, and a second scroll correspondence amount based on a second displacement correspondence amount corresponding to the displacement amount of the pointer in a second direction orthogonal to the first direction on the screen,
the input apparatus further comprising
an output controller to control the output section so that, when the first displacement correspondence amount is smaller than the second displacement correspondence amount during the second mode, the output of the first scroll correspondence amount is stopped.

12. The input apparatus according to claim 7,
wherein one of the scroll correspondence amount and the zoom correspondence amount has a value the same as that of the displacement correspondence amount.

13. The input apparatus according to claim 1,
wherein the mode switch section carries out one of a switch of any of the first mode, the second mode, and the third mode to any other one of the first mode, the second mode, and the third mode every time a predetermined time passes since a start of the operation to the operation section until the operation is canceled, and a switch of any of the first mode, the second mode, and the third mode to any other one of the first mode, the second mode, and the third mode every time the operation section is operated.

14. The input apparatus according to claim 1,
wherein the operation section is a two-step operation section capable of performing a two-step switch.

15. The input apparatus according to claim 1,
wherein the sensor includes at least one of a biaxial angular velocity sensor, a biaxial acceleration sensor, and a biaxial angle sensor.

16. An input apparatus controlling a movement of a pointer and an image displayed on a screen, the input apparatus comprising:
a casing;
a sensor to detect a physical amount corresponding to a movement of the casing;
a single operation section through which an operation is input;
a command output section to output a determination command in accordance with the operation to the operation section;
a mode switch section to make a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section; and
a controller to control the command output section and the mode switch section so that one of the output of the determination command and the switch of any of the first mode, the second mode, and the third mode is executed in accordance with a timing of the operation to the operation section.

17. A control apparatus controlling display of a pointer and an image displayed on a screen in accordance with information output from an input apparatus, the control apparatus comprising:
a casing,
a sensor to detect a physical amount corresponding to a movement of the casing,
an operation section through which an operation is input,
a mode switch section to make a switch among a first mode for moving the pointer on the screen based on the physical amount,
a second mode for scrolling the image on the screen based on the physical amount, and
a third mode for zooming in/out on the image on the screen based on the physical amount, in accordance with the operation to the operation section, a calculation section to calculate a displacement correspondence amount corresponding to a displacement amount of the pointer that corresponds to the physical amount, and
an output section to output information on the displacement correspondence amount and mode switch information as information indicating the switch of any of the first mode, the second mode, and the third mode to any other one of the first mode, the second mode, and the third mode, wherein:
the reception section receives the information on the displacement correspondence amount and the mode switch information;
the calculation section calculates a scroll correspondence amount corresponding to a scroll amount of the image based on the displacement correspondence amount during the second mode, and calculate a zoom correspondence amount corresponding to a zoom amount of the image based on the displacement correspondence amount during the third mode; and
the display controller controls display of a movement of the pointer by the displacement correspondence amount, display of scroll of the image by the scroll correspondence amount, and display of zoom of the image by the zoom correspondence amount.

18. A control apparatus receiving, from an input apparatus comprising:
a casing,
a sensor to detect a physical amount corresponding to a movement of the casing, and
an operation section through which an operation is input, information on the physical amount and information on the operation, and controlling display of a pointer and an image displayed on a screen, wherein
the reception section receives the information on the physical amount and the information on the operation,
the calculation section calculates a displacement correspondence amount corresponding to a displacement amount of the pointer on the screen that corresponds to the information on the physical amount, a scroll correspondence amount corresponding to a scroll amount of the image on the screen that corresponds to the information on the physical amount, and a zoom correspondence amount corresponding to a zoom amount of the image on the screen that corresponds to the information on the physical amount; and
the mode switch section makes a switch among a first mode for controlling display of a movement of the pointer based on the displacement correspondence amount, a second mode for controlling display of scroll of the image based on the scroll correspondence amount, and a third mode for controlling display of zoom of the image based on the zoom correspondence amount, in accordance with the information on the operation.

19. A control system controlling display of a pointer and an image displayed on a screen, the control system comprising:
an input apparatus including
a casing,
a sensor to detect a physical amount corresponding to a movement of the casing,
an operation section through which an operation is input,
a mode switch section to make a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section,
a calculation section to calculate a displacement correspondence amount corresponding to a displacement amount of the pointer that corresponds to the physical amount, a scroll correspondence amount corresponding to a scroll amount of the image that corresponds to the physical amount, and a zoom correspondence amount corresponding to a zoom amount of the image that corresponds to the physical amount, and
an output section to output information on the displacement correspondence amount during the first mode, information on the scroll correspondence amount during the second mode, and information on the zoom correspondence amount during the third mode; and
a control apparatus including
a reception section to receive the information on the displacement correspondence amount, the information on the scroll correspondence amount, and the information on the zoom correspondence amount, and
a display controller to control display of a movement of the pointer by the displacement correspondence amount, display of scroll of the image by the scroll correspondence amount, and display of zoom of the image by the zoom correspondence amount.

20. A handheld apparatus controlling a movement of a pointer and an image displayed on a screen, the handheld apparatus comprising:
a casing;
a display section to display the screen;
a sensor to detect a physical amount corresponding to a movement of the casing;
an operation section through which an operation is input;
a mode switch section to make a switch among a first mode for moving the pointer on the screen based on the physical amount, a second mode for scrolling the image on the screen based on the physical amount, and a third mode for zooming in/out on the image on the screen based on the physical amount, in accordance with the operation to the operation section; and
a display controller to control display of the movement of the pointer during the first mode, display of scroll of the image during the second mode, and display of zoom of the image during the third mode.
